(19) United States
(12) Patent Application Publication
(10) Pub. No.: US 2021/0235936 A1
(43) Pub. Date: Aug. 5, 2021

(54) AGITATOR FOR BREWING, STEEPING OR INFUSING A LIQUID

(71) Applicant: Kinetic Ideations, Inc., Sunnyvale, CA (US)

(72) Inventors: Mike SJAASTAD, Sunnyvale, CA (US); Lou LEDERER, Sunnyvale, CA (US)

(21) Appl. No.: 17/266,484

(22) PCT Filed: Aug. 7, 2019
(86) PCT No.: PCT/US2019/045499

§ 371 Date: Feb. 5, 2021

Related U.S. Application Data
(60) Provisional application No. 62/716,805, filed on Aug. 9, 2018.

(51) Int. Cl. A47J 43/27; A47J 31/44; A47J 31/06

(52) U.S. Cl. CPC A47J 43/27; A47J 31/06; A47J 31/44

(57) ABSTRACT

Device and method embodiments discussed herein may be used to enhance a brewing process, steeping process, infusing process or extraction process. Such infusion processes may be used for making coffee, tea, oil, alcohol or any other suitable infused liquid where a user desires to enhance or control such a process.

### RELATED APPLICATIONS

This application is a national stage application under 35 U.S.C. section 371, which claims the benefit of priority to PCT Application No. PCT/US2019/045499, having a filing date of Aug. 7, 2019, titled “AGITATOR FOR BREWING, STEEPING OR INFUSING A LIQUID”, which claims priority from U.S. Provisional Patent Application Ser. No. 62/716,805 filed Aug. 9, 2018, by M. Sjaastad et al., titled “Agitator for Brewing, Steeping or Infusing a Liquid”, each of which is hereby incorporated by reference herein in its entirety.

### BACKGROUND

There is a wide and ever increasing variety of consumer products for consumption that may be at least partially processed by the extraction of solid and/or aromatic materials and infusing them into liquids. Coffee and tea are, of course, two of the most common of such products in demand. As consumers of such products have become more familiar with different varieties and qualities of these products, their tastes have become more sophisticated over time and, in many cases, more demanding with regard to the quality and varying properties of such products. Although a variety and quality of raw materials for such brewed or infused products has increased dramatically in the recent past, what has been needed are devices and methods for consumers to control at least some of the properties, tastes and characteristics of such infused products.

### SUMMARY

Some embodiments of an agitator for enhancing infusion of a liquid may include a filter container which has a wall disposed about an interior cavity and a filter portion in the wall including a plurality of passages that allow the passage of liquid but prevent the passage of ground material. The agitator also includes a base secured to a bottom of the filter container, a vibration source operatively coupled to the base and a power source operatively coupled to the vibration source. The agitator further includes a controller in operative communication with the vibration source.

Some embodiments of an agitator for enhancing infusion of a liquid may include an elongate stirring wand having a proximal handle section and a stir section that extends distally from the proximal handle section. The elongate stirring wand further includes a vibration source operatively coupled to the elongate stirring wand, a power source operatively coupled to the vibration source and a controller in operative communication with the vibration source.

Some embodiments of an agitator for enhancing infusion of a liquid may include a refillable cartridge for cartridge based brewing machines, including a wall disposed about an interior cavity, a filter portion in the wall including a plurality of passages that allow the passage of liquid but prevent the passage of ground material. The refillable cartridge may further include a base secured to a bottom of the filter container, a vibration source operatively coupled to the base and a power source operatively coupled to the vibration source. The refillable cartridge may also include a controller in operative communication with the vibration source.

Some embodiments of an agitator for enhancing infusion of a liquid may include a refillable cartridge for cartridge based brewing machine, including a wall disposed about an interior cavity, a filter portion in the wall including a plurality of passages that allow the passage of liquid but prevent the passage of ground material. The refillable cartridge may also include a base secured to a bottom of the filter container, a vibration source operatively coupled to the wall, a power source operatively coupled to the vibration source, and a controller in operative communication with the vibration source.

Some embodiments of an agitator for enhancing infusion of a liquid may include a housing having an annular configuration, an upper surface, a lower surface which is parallel to the upper surface, and a central aperture extending from the upper surface to the lower surface. The agitator may further include a vibration source which is operatively coupled to the housing, a power source operatively coupled to the vibration source, and a controller in operative communication with the vibration source.

Some embodiments of an agitator for enhancing infusion of a liquid may include a vibration source configured to be operatively coupled to an infusion mixture so as to effectively transmit vibration energy from the vibration source to the infusion mixture. A power source may be disposed in operative communication with the vibration source and a controller disposed in operative communication with the vibration source. In some cases, the controller may be configured to receive input from a user to control the intensity of vibration energy emitted from the vibration source and the duration of the vibration energy emitted from the vibration source.

Some embodiments of a method for enhancing infusion of a liquid may include securing an agitator in operative communication with the infusion mixture, selecting vibration energy emission characteristics and inputting these characteristics into a controller of the agitator. The method may also include emitting vibration energy having the selected vibration energy emission characteristics from a vibration source which is in communication with and being controlled by the controller into the infusion mixture in order to control and enhance the infusion process.

Some embodiments of an agitator for enhancing infusion of a liquid may include a radiator having a radiator body with an elongate outer contour, a proximal end, a distal end and a longitudinal axis. The agitator may further include a flange secured to the radiator adjacent the proximal end of the radiator body. In some cases, the flange may be disposed lying transverse to and extending axially from the longitudinal axis of the radiator body. A vibration source may be operatively coupled to the radiator body and a power source operatively coupled to the vibration source. In addition, a controller may be disposed in operative communication with the vibration source.

Some embodiments of a method of enhancing infusion of a liquid may include inserting a radiator of an agitator into an infusion mixture and selecting vibration energy emission characteristics and inputting these characteristics into a controller of the agitator. The method may further include emitting vibration energy having the selected vibration energy emission characteristics from a vibration source of the agitator into the infusion mixture in order to control and enhance an infusion process.

Some embodiments of an agitator for enhancing infusion of a liquid may include a filter container having a wall with a funnel shaped contour, an upper opening, at least one lower opening that is smaller than the upper opening and a receptacle. The agitator embodiment may further include a modular agitator assembly, having a vibration source, a power source operatively coupled to the vibration source, and a controller in operative communication with the vibration source. In addition, the modular agitator assembly may further include an enclosure wherein the vibration source, power source and controller are disposed within the enclosure. Such an enclosure may have an outer surface which is sized and configured to be removably inserted into the receptacle with the vibration source in operative communication with an interior volume of the filter container.

Some embodiments of a method of enhancing infusion of a liquid include disposing an agitator into operative communication with an infusion mixture, selecting vibration energy emission characteristics and inputting these characteristics into a controller of the agitator and emitting vibration energy having the selected vibration energy emission characteristics from a vibration source of the agitator into the infusion mixture over a period of time. The method may also include selectively extracting a first component of a solid material of the infusion mixture into the liquid of the infusion mixture relative to a second component of the solid material in order to control and enhance an infusion process.

Certain embodiments are described further in the following description, examples, claims and drawings. These features of embodiments will become more apparent from the following detailed description when taken in conjunction with the accompanying exemplary drawings.

### BRIEF DESCRIPTION OF THE DRAWINGS

FIG. 1 is a schematic representation of an agitator wherein a vibration source, controller and power source have been combined in a single unit.

FIG. 2A is a schematic representation of the agitator of FIG. 1.

FIG. 2B is a schematic representation of an agitator wherein a vibration source is disposed in a unit separate from but in operative communication with a controller and power source.

FIG. 2C is a schematic representation of an agitator wherein a vibration source and power source are disposed in a unit separate from but in wireless communication with a controller.

FIG. 2D is a schematic representation of an agitator wherein a vibration source and controller of the agitator are disposed in a unit separate from but in operative communication with a power source.

FIG. 3A is a schematic representation of an agitator embodiment secured to an adjustable elastic band.

FIG. 3B is a schematic representation of an agitator embodiment as shown in FIG. 3A releasably secured to a brewing vessel in either a horizontal or vertical type orientation.

FIG. 4A is a schematic representation of an agitator embodiment built into a base of a pour over type filter container.

FIG. 4B is a schematic representation of an agitator embodiment which is releasably secured to a pour over type filter container using magnets.

FIG. 4C is a schematic representation of an agitator embodiment which is releasably secured to a pour over type filter container using a clip attachment.

FIG. 5A is a schematic representation of an agitator embodiment including an adjustable elastic band.

FIG. 5B is a schematic representation of the agitator embodiment of FIG. 5A with the adjustable elastic band releasably secured to a cold brew brewing vessel.

FIG. 5C is a schematic representation of the agitator embodiment of FIG. 5A operatively coupled to a brewing filter container.

FIG. 6 is a perspective view of an agitator embodiment having a flange and a radiator with an elongate profile that may be inserted into an infusion mixture of a liquid and a solid material for brewing control and enhancement.

FIG. 7 is an exploded view of the agitator embodiment of FIG. 6 and further including a filter container into which the radiator of the agitator may be inserted during operation.

FIG. 8 is a perspective view in longitudinal section of the agitator of FIG. 7 with the radiator thereof disposed within an interior volume of the filter container.

FIG. 9 is a transverse cross section view of the agitator and filter container of FIG. 8 taken along lines 9-9 of FIG. 8.

FIG. 10 is a transverse cross section view of the agitator and filter container of FIG. 8 taken along lines 10-10 of FIG. 8.

FIG. 11 is an elevation view of the agitator of FIG. 7 being inserted by a user into a filter container which is, in turn, disposed within an interior volume of a brewing vessel of a cold brewing system embodiment.

FIG. 12 is an elevation view of the agitator of FIG. 7 fully inserted by the user into the interior volume of the filter container which is, in turn, disposed within an interior volume of the brewing vessel of the cold brewing system.

FIG. 13 is an exploded view of an agitator embodiment having a plurality of radial extensions and a pour over type filter container.

FIG. 14 is a perspective view of the agitator embodiment of FIG. 13 having a plurality of radial extensions and with the radiator disposed within an interior volume of a pour over type filter container with the plurality of radial extensions in contact with an upper rim of the pour over type filter container.

FIG. 15 is an elevation view of an agitator embodiment that is releasably secured to a pour over type filter container with a receptacle type attachment.

FIG. 15A is a section view of the pour over type filter container with clip attachment of FIG. 15 taken along lines 15A-15A and shown without the agitator for clarity of illustration.

FIG. 16 is a bar graph illustrating caffeine concentration versus brew time and vibration intensity.

FIG. 17 is a bar graph illustrating a measurement of coffee brew solids versus brew time and vibration intensity.

FIG. 18 is a bar graph illustrating a measurement of caffeine concentration and brew solids concentration versus brew time and vibration intensity for a cold brewing process.

FIG. 19 is a table of vibration energy output characteristic embodiments.

FIG. 20 is an elevation view in section of a large capacity infusion urn.

FIG. 21 is a perspective view of an agitator embodiment including a filter container.

FIG. 22 is a top view of a base of the agitator embodiment of FIG. 21.

FIG. 23 is a perspective view of an agitator embodiment including a radiator and a filter container.

FIG. 24 is a top view of a base of the agitator embodiment of FIG. 23.

FIG. 25 is a front view of an agitator embodiment that may be used for stirring.

FIG. 26 is a front view of an agitator embodiment that may be used for stirring.

FIG. 27 is a perspective view of an agitator embodiment that may be used for stirring an infusion mixture.

FIG. 28 is a front view of the agitator embodiment of FIG. 27.

FIG. 29 is a side view of the agitator embodiment of FIG. 27.

FIG. 30 is an elevation view in partial section of the agitator embodiment of FIG. 29 taken along lines 30-30 of FIG. 29.

FIG. 31 is a transverse cross section view of the agitator embodiment of FIG. 30 taken along lines 31-31 of FIG. 30.

FIG. 32 is an elevation view of a circuit board embodiment and battery embodiment of the agitator embodiment of FIG. 30.

FIG. 33 is a front view of the circuit board embodiment and battery embodiment of FIG. 32.

FIG. 34 is a top view of a motor embodiment and eccentric weight embodiment of the agitator embodiment of FIG. 30.

FIG. 35 is a side view of the motor embodiment and eccentric weight embodiment of FIG. 34.

FIG. 35A shows a stir section of the agitator embodiment of FIG. 27 disposed in contact with an infusion mixture which is disposed within a cavity of a filter container embodiment.

FIG. 36 is an exploded perspective view of a standard refillable cartridge embodiment.

FIG. 37 is an exploded perspective view of an agitator embodiment including a refillable cartridge embodiment.

FIG. 37A is a top view of the base of the agitator embodiment of FIG. 37.

FIG. 38 is a perspective view of an agitator embodiment including a refillable cartridge embodiment.

FIG. 38A is an enlarged view in section of a housing of the agitator embodiment of FIG. 38.

FIG. 39 is an exploded view of an agitator embodiment disposed between a brewing vessel in the form of a cup and a pour over filter container embodiment.

FIG. 40 is an elevation view of the agitator embodiment of FIG. 39, which is releasably secured to the pour over filter container embodiment of FIG. 39 by clip embodiments.

FIG. 41 is a perspective view of the pour over filter container embodiment releasably secured to the agitator embodiment of FIG. 39 by multiple techniques, either or both of which may be used for certain embodiments.

FIG. 42 is a top view of a housing of the agitator embodiment of FIG. 39.

The drawings are intended to illustrate certain exemplary embodiments and are not limiting. For clarity and ease of illustration, the drawings may not be made to scale and, in some instances, various aspects may be shown exaggerated or enlarged to facilitate an understanding of particular embodiments.

### DETAILED DESCRIPTION

Agitator embodiments discussed herein are configured to emit vibration energy into to an infusion mixture consisting of solid material (which may include one or more types of ground or finely ground particles) immersed in a liquid. The emission of vibration energy may be performed in a controlled manner in order to enhance the extraction of solids, liquids or any desired chemicals or components of the solid material into the liquid of the infusion mixture. For example, a hot or cold brewing process, hot or cold steeping process, or, more generally, a hot or cold infusion process may be enhanced and/or controlled with embodiments of the agitators discussed herein. Such infusion control and enhancement may be used, for example, in the preparation of infused liquids such as coffees, teas, oils, alcoholic beverages including flavored alcoholic beverages and the like. In some cases, the vibration frequency, intensity, pattern, total time period, time schedule, or locality of vibration energy directed into an infusion mixture may be defined and controlled by the user. Vibration energy control may be achieved via a local controller on the device to provide user tunable vibration energy features or by the use of external methods such as a computer program or mobile phone application that provides a wired connection or wirelessly accesses agitator embodiments in order to tune such an infusion process specifically to the user's desired preferences.

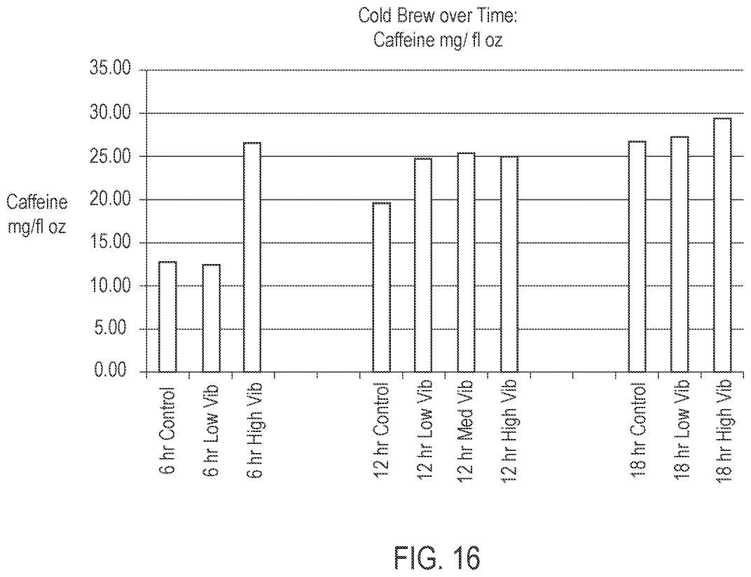

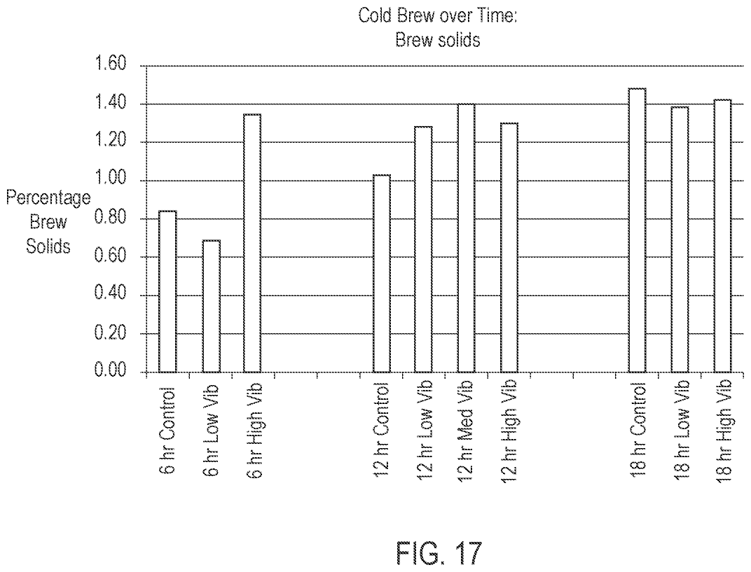

It is generally believed by the inventors that the application of certain types and schedules of vibration energy to infusion mixtures may cause agitation, convection, mixing etc. of the solid material relative to the liquid so as to accelerate the infusion and/or extraction of one or more aromatic flavorful materials from the solid material into the liquid that surrounds the solid material so as to create an infused liquid. In addition to the acceleration of the infusion/extraction process, the application of certain types of vibration energy may also alter the rate of infusion/extraction of one type of extracted component over another so as to allow some selectivity of the infusion/extraction of certain components of an infused liquid that results from the infusion/extraction process. Examples of such selectivity may be found in the exemplary bar graph data of FIGS. 16-18. Tunability of the infusion/extraction process by adjustment of properties of agitation may be used to selectively enhance or ameliorate individual characteristic (composition and flavor) of the resulting infused liquid or beverage. As discussed above, manipulating the characteristics of the vibration energy and the resulting agitation of an infusion mixture may be used for effectively tuning the infusion/extraction process for a desired outcome of individual tastes. An example of this is shown in FIG. 16 where a selective increase of caffeine extraction during an 18 hour cold brew coffee preparation was measured relative to other components such as brew solids over time with increasing intensity of agitation. Increasing levels of agitation increased the rate and total amount of caffeine extraction. Importantly, similar concentrations of caffeine were present in 6 hours with high agitation as were present only after 12 or 18 hours of normal cold brew process. This effectively shortens the time required to create a more caffeinated beverage or allow a more caffeinated beverage at any brew duration.

This example demonstrates that caffeine levels can be selectively tuned, and significantly increased at shorter duration on a brew process with particular types of agitation. It also suggests that it is possible to produce a more caffeinated beverage using agitation than without. Similarly, FIG. 17 displays that the percentage of brew solids (a measurement of “strength” of the coffee taste) in the cold brew are increased to a varying degree depending upon intensity of agitation. It may be noted that subjective evaluation of the resulting cold brew coffee in blind taste tests by coffee analysis experts demonstrated that other qualities of coffee such as: flavor, body, aroma, acidity and finish are impacted independently by varying the intensity and duration of agitation (data not shown). Taken together the data of FIGS. 16-18 demonstrates that varying the characteristics of vibration energy and resulting agitation may enable individuals to tune or customize the infusion process to selectively produce a beverage to their composition and taste preferences.

Some agitator embodiments may be integral to the brewing/steeping/infusing system or components thereof (e.g. a vibration source built into the brewing, steeping, or infusion device or equipment) or they may include agitator embodiments that may be used as a platform or may be attached and removed from already existing brewing, steeping or infusing systems. For example, a vibration source with intensity and time controls may be attached to a pour over type filter container or brewing vessel. In addition, a vibration source may be permanently or releasably attached to the outside portion of a cold brewing vessel to provide vibration energy to the water and coffee grounds of the infusion mixture to control and enhance such a brewing process.

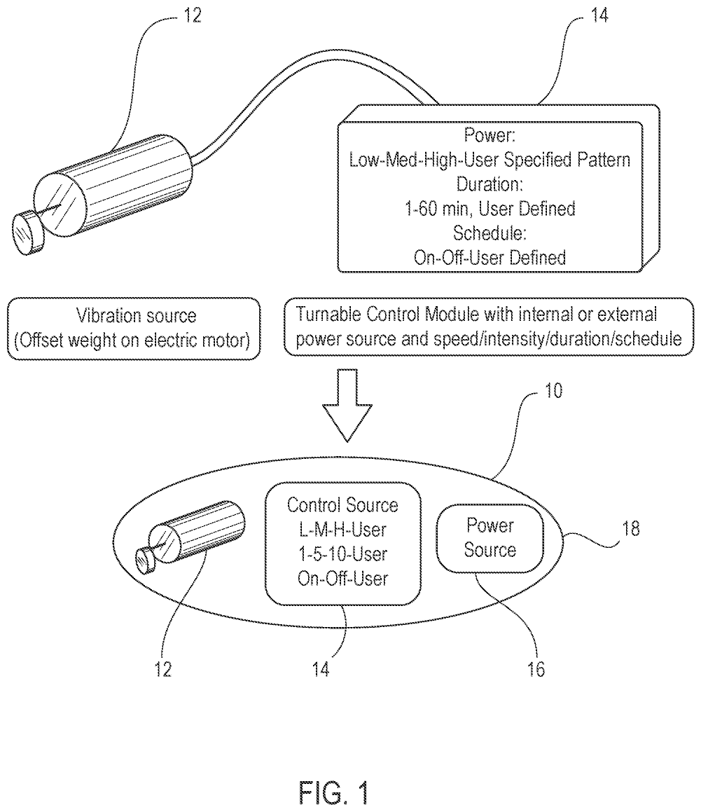

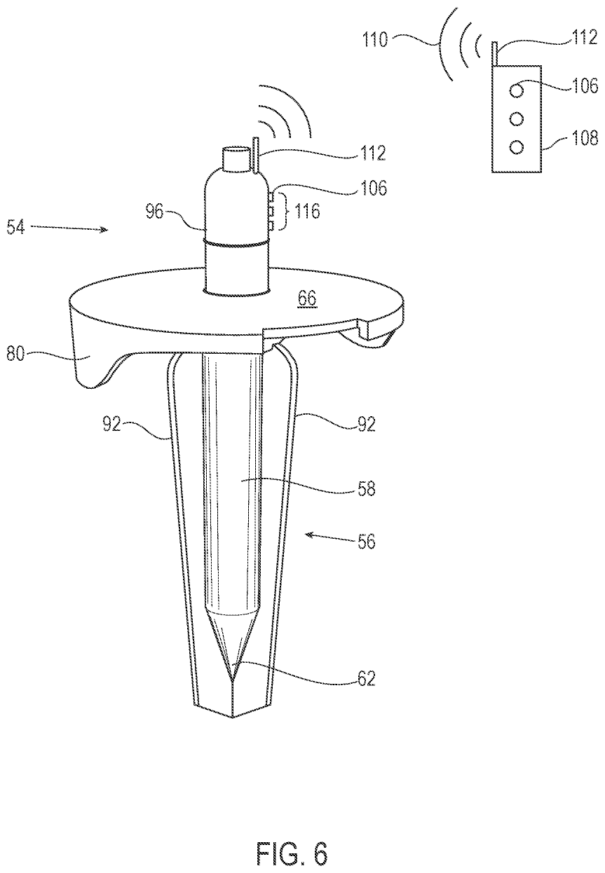

With regard to certain exemplary embodiments, FIG. 1 schematically illustrates components of an embodiment of a brewing control device also referred to herein as an agitator 10 that may include user tunable features in some cases. The components of the agitator 10 may include a vibration source 12, which may include an offset weight on a shaft of an electric motor. A control source which is also referred to herein as a controller 14 may be configured to let a user specify the power or intensity of vibration, duration of vibration, vibration schedule etc. as a means of controlling and enhancing the brewing or infusion process. The controller 14 may be embedded in the agitator 10 and controlled by buttons (as shown in the embodiment of FIG. 6) or it may be controlled remotely via a wired connection, or a wireless connection to a mobile application. A power source 16 may include replaceable batteries, rechargeable batteries, or a connection to an external power source.

According to FIG. 1, the vibration source 12, controller 14 and power source 16 may be embodied together in a single inclusive unit or module disposed within or otherwise secured to a housing. In some cases, the power source 16 and controller 14 may be disposed external to but in operative communication with the vibration source 12. Although the vibration source 12 shown includes an offset or out of balance weight that may be rotated by an electric motor in order to produce vibration energy that may be emitted from the vibration source 12, any other suitable form of vibration source 12 may be used. Vibration source embodiments 12 may include any mechanism that is configured to convert electrical energy (or any other suitable form of energy) into vibrational energy. For example, some vibration source embodiments 12 may include piezoelectric vibration sources, solenoid driven vibration sources, voice coil driven vibration sources, bi-metal film driven vibration sources or the like.

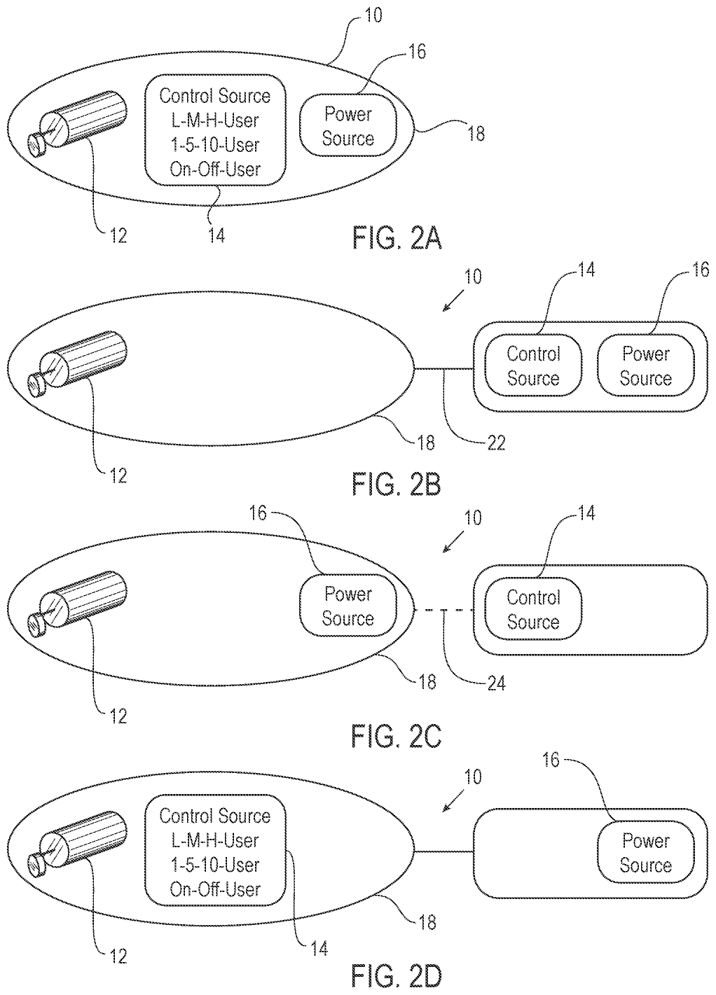

FIGS. 2A-2D illustrate embodiments of a power source 16, controller 14 and vibration source 12 configuration options for some agitator 10 and method embodiments discussed herein. The controller 14 for the agitator 10 may be disposed within or otherwise secured to a housing 18 with the vibration source 12 as shown in FIGS. 2A and 2D. The controller may also include a wired connection 22 to a separate controller physically separated from the power source and vibration source as shown in FIG. 2B or a wireless connection 24 to a separate controller 14 having a mobile application (such as is typically used on a smart phone) as shown in FIG. 2C. The power source 16 (including either replaceable or rechargeable batteries) may reside on the agitator 10 as shown in FIGS. 2A and 2C or the power source 16 may include an external power source 16 as shown in FIGS. 2B and 2D. Embodiments of such an external power source 16 may plug into a common household wall socket, include one or more batteries (either replaceable or rechargeable) or any other suitable power source. For some embodiments, the vibration source 12 may be attached firmly to the brewing, steeping, or infusion system. The agitator 10 may be self-contained such that built into it is a vibration source 12, controller 14, and power source 16. Alternatively, the agitator 10 may include an external power source attached by wires. Also, the agitator embodiments 10 may have an external controller 14 that is coupled via wires 22 or via a wireless link 24, and the controller 14 may be controlled via a mobile application as discussed above.

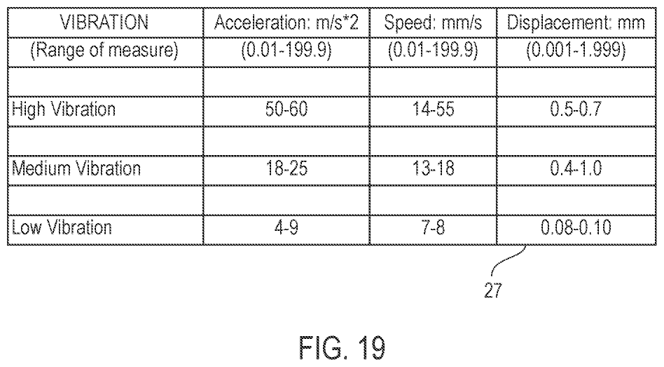

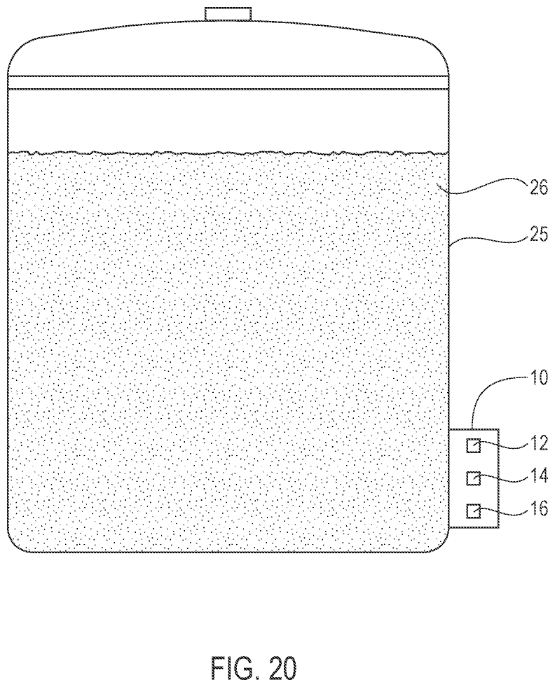

In many cases, an end user may desire to brew/steep/infuse products to their personal desired specifications based on enhancement and control of the process through tunable vibration energy being coupled to their own existing brewing system. To do this on a fully self-contained agitator embodiment 10, the user may first attach the agitator embodiment 10 to the user's brewing vessel to which they want to apply tunable vibration energy. The user may then select the buttons to control all available vibration energy variables. These variables may include vibration intensity, vibration duration and vibration pattern or schedule. In some cases, embodiments may include any method in which user tunable vibration is applied to the brewing, steeping or infusing process. Also, the agitator 10 and method embodiments discussed herein may be built into commercial products (such as the high volume urn 25 shown in FIG. 20) or may be configured as removable devices that may be releasably and operatively secured to a user's existing brewing system or components thereof.

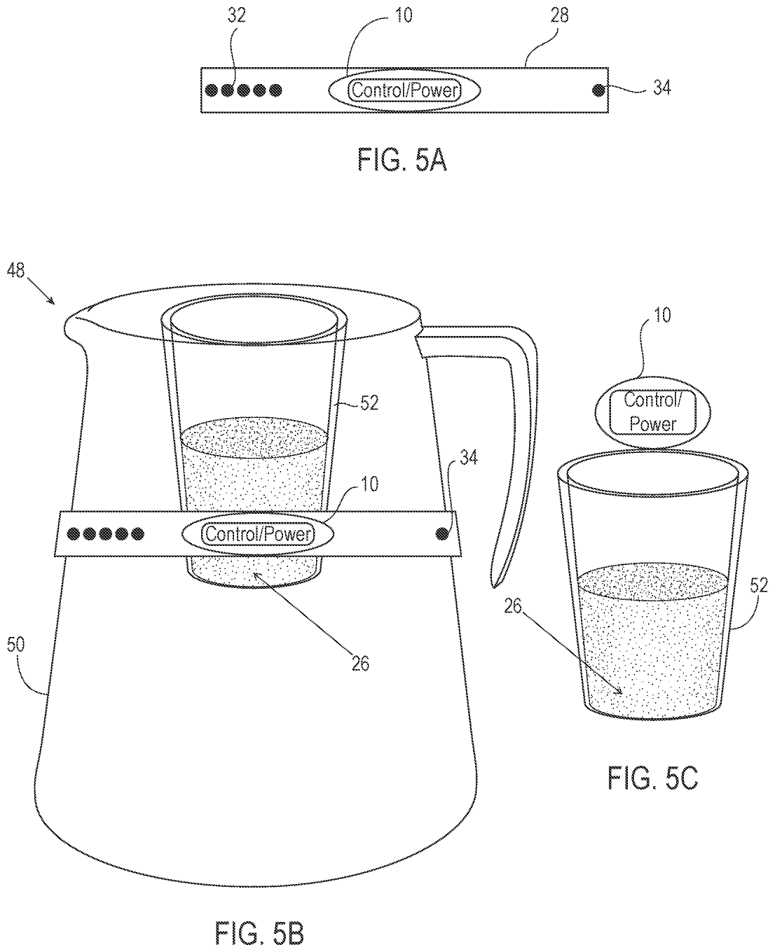

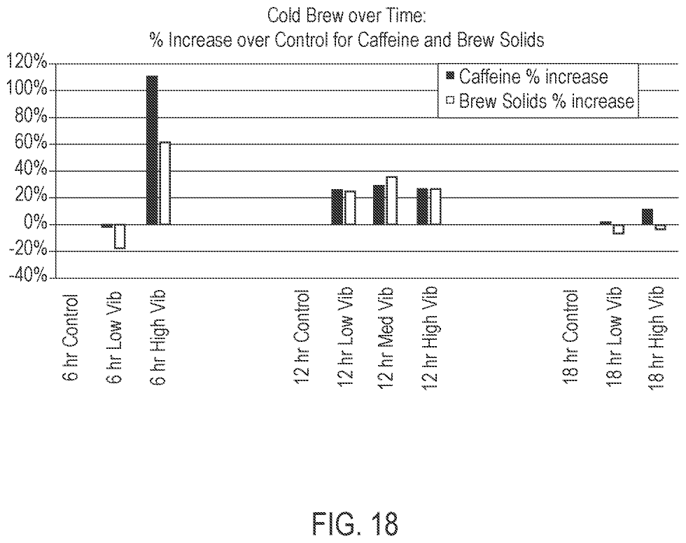

As shown in the agitator embodiments 10 illustrated in FIGS. 1-2D and discussed above, some controller embodiments 14 may be configured to set a power level of vibration energy applied to an infusion mixture 26 (shown in FIGS. 5B-5C) at a plurality of different power levels. For example, the vibration energy power level may be set to a low, medium or high power level setting by a user. In addition, for the embodiment 10 shown in FIGS. 1-2D, the duration time over which vibration energy is generated by and emitted from the vibration source may be set to a time from about 1 minute to about 60 minutes (as shown in FIG. 1), in some cases. The user, in some instances, may set the duration of operation of the vibration source to a pre-selected time period chosen from a menu of pre-selected time periods, such as a pre-selected time period of 1 minute, 5 minutes, 10 minutes or any other suitable pre-selected time period (as shown in FIG. 1). The controller may also be configured to provide “on-off” control of the vibration source to the user. In addition, the characteristics of the vibration energy produced by and emitted from the vibration source may be tuned or selected by a user. As shown in the chart 27 of FIG. 19, some vibration source embodiments 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. In addition, some vibration source embodiments 12 may be configured to produce vibration having a vibration acceleration of about 4 m/s2 to about 60 m/s2, a vibration speed of about 7 mm/s to about 55 mm/s, and a vibration displacement of about 0.08 mm to about 0.7 mm. Any of the vibration source embodiments may be configured to produce vibration energy having any suitable combination of parameter values shown in the chart 27 of FIG. 19. In addition, any of the vibration source embodiments discussed herein may be configured to emit vibration energy having any other suitable parameters including ultrasonic vibration energy, low frequency energy of about 1 Hz to 60 Hz or any suitable frequency in between ultrasonic and low frequency, for example about 1 Hz to about 10,000 Hz in some cases.

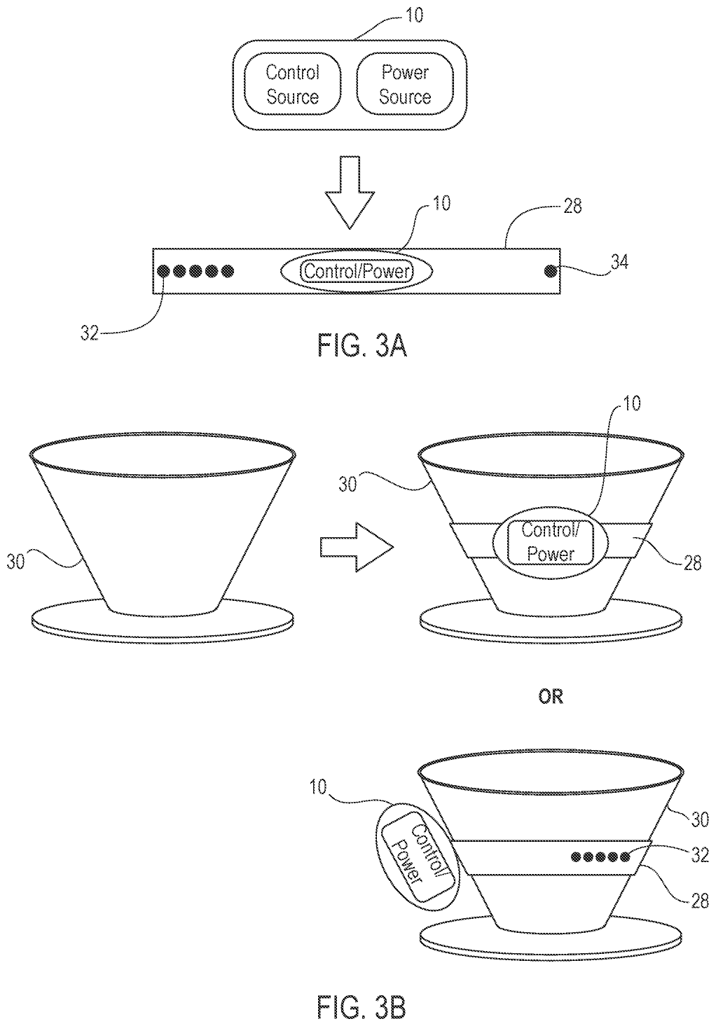

FIGS. 3A and 3B illustrate embodiments of an agitator 10 which includes a power source 16, controller 14 and vibration source 12 (not shown) and which may have any of the suitable features, dimensions or materials of other agitator embodiments discussed herein. The agitator 10 may be secured to a band, such as an adjustable elastic silicone band 28 (or any other suitable type of band) in which the band may be removably and operatively secured to a brewing system or components thereof such that vibration energy may be transferred to an infusion mixture in the brewing system to enhance a process of brewing, steeping, or infusing the infusion mixture to produce a desired infused liquid. In some cases, such embodiments may be used for applying vibration energy to a pour over type filter container 30 of a brewing system. In this example, the adjustable band 28 may be used that has holes 32 through a section of the band 28 along one end of the band similar to a wristwatch band. A raised grooved knob 34 is disposed on an end of the band 28 which is opposite that of the holes 32 as shown in FIG. 3A. For such a configuration, it may be desirable for the through holes 32 to be sized slightly smaller than an outer transverse dimension of the raised grooved knob 34 such that a hole 32 may be elastically enlarged and placed over the knob 34 to ensure a secure fit attachment that may be subsequently released by lifting the band 28 adjacent the knob 34 in a radially outward direction and pulling the band 28 off the knob 34. Also, the agitator 10 may be mounted vertically or horizontally on the band 28 as shown in FIG. 3B. The agitator 10 may also be removed from the band 28 in some instances if desired.

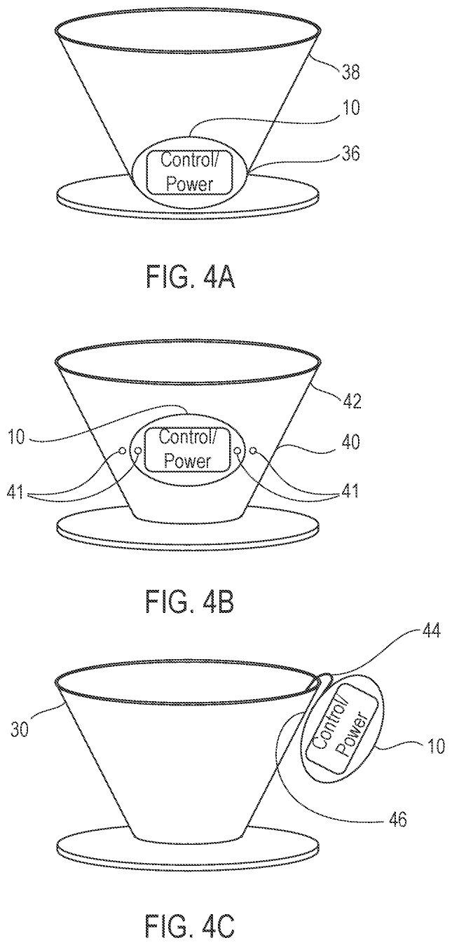

FIG. 4A illustrates an attachment method embodiment wherein an agitator 10 is built into a base 36 of a coffee pour over vessel 30. FIG. 4B illustrates an attachment method embodiment wherein magnets 41 are included in a wall 40 of a pour over type filter container of a brewing system. Magnets 41 may also be included on a corresponding agitator 10 such that there is a releasable magnetic attachment between the wall 40 of the pour over type filter container 42 and the agitator 10 when in close proximity with each other. An additional example of an attachment embodiment includes an agitator 10 having a clip attachment 44 (the clip attachment may include an alligator type clip in some cases) such that the agitator 10 may be releasably secured to an upper wall 46 of a pour over type filter container 30 (or any other suitable container or vessel of a brewing system or the like) as shown in FIG. 4C. For each of the embodiments shown in FIGS. 4A-4C, it may be desirable for the vibration source 12 (not shown) of each of the respective embodiments to mechanically couple to the wall of the pour over type filter container so as to effectively transfer vibration energy from the vibration source 12 to the wall of the pour over type filter container and the interior volume thereof and any infusion mixture 26 contained therein.

FIGS. 5A-5C illustrate embodiments of the implementation of cold brew processes for beverages such as coffee, tea or the like using an attachment accessory such as the adjustable band 28 discussed above or any other suitable adjustable band. As shown in FIG. 5A, some agitator embodiments 10 may include an adjustable band 28 which may be configured to be releasably and operatively secured to a brewing system (or component thereof) including a cold brewing system 48. In some cases, the agitator embodiment 10 may be secured to an outside surface of a cold brewing vessel 50 of a brewing system 48 (or other suitable vessel) as shown in FIG. 5B or secured to a filter container 52 of such a cold brewing system 48 as shown in FIG. 5C. In some cases, the agitator 10 may be secured to commercially available cold brewing systems 48 or incorporated into a cold brewing system as part of the components of such a fully integrated cold brewing system 48. In addition, embodiments of the agitator 10 may be part of the filter apparatus such as the filter container 52 or removably attached to the cold brewing vessel 50 (such as a carafe) itself.

In any of the arrangements discussed with regard to FIGS. 5A-5C, the vibration source 12 of the agitator 10 may be operatively coupled to the infusion mixture 26 such as coffee grounds, tea grounds or the like disposed within the filter container 52 or brewing vessel 50 with water or any other suitable liquid so as to effectively transmit vibration energy from the vibration source to the infusion mixture 26 and effectively agitate the infusion mixture 26 so as to control and enhance the infusion process. Examples of infusion process control and enhancement may be illustrated in some cases by the bar graph data shown in FIGS. 16-18. Such an arrangement as shown in FIGS. 5A-5C may allow a retrofit to existing methods or development of a fully integrated brewing system 48. Similarly, this may be used for steeping tea, infusing oils or alcoholic beverages as well as other materials.

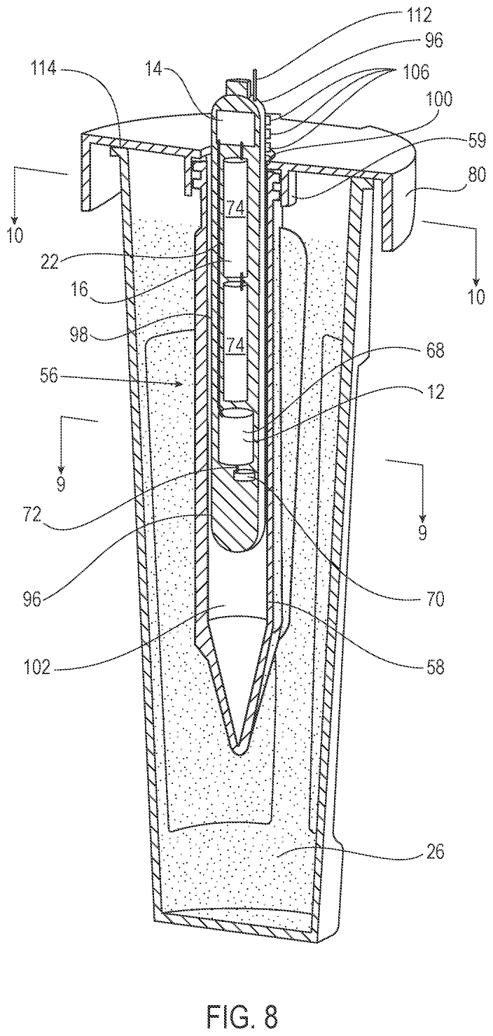

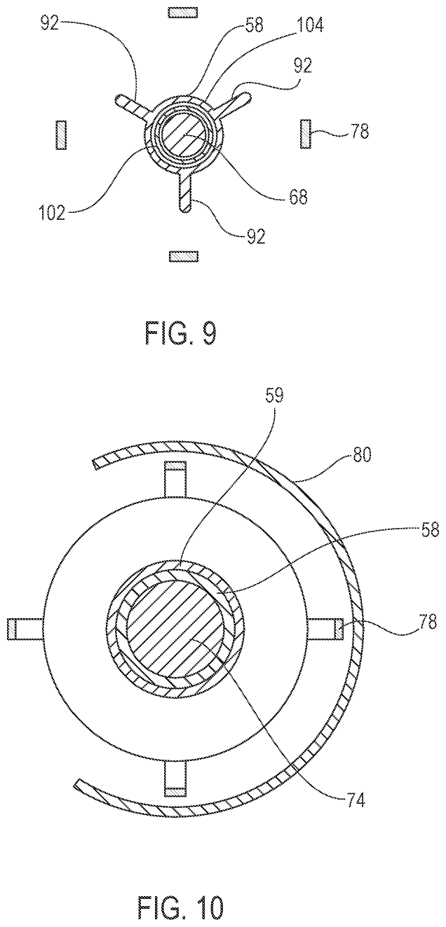

In some cases, it may be desirable to have an agitator 10 that is configured for use with existing brewing systems while directly contacting and coupling vibration energy to an infusion mixture 26 disposed within the existing brewing system 48. For example, FIGS. 6-14, show an agitator 54 for enhancing infusion of a liquid that includes a radiator 56 having a radiator body 58 with an elongate outer contour, a proximal end 60, a distal end 62 and a longitudinal axis 64. The agitator 54 may further include a flange 66 secured to the radiator 56 adjacent the proximal end 60 of the radiator body 58. The flange 66 may include a tubular extension 59 extending distally from a center portion or any other suitable portion of the flange 66, the tubular extension being configured to secure the proximal end 60 of the radiator body 58 to the flange 66. In some cases, the outside surface of the proximal end 60 of the radiator body 58 may have threads that couple to inner threads of an inner surface of the tubular extension 59 of the flange 66. In addition to the threaded coupling, any other suitable method may also be used to secure the proximal end 60 of the radiator body 58 to the flange including adhesive bonding, welding, unity of construction in a monolithic structure etc. In some cases, the flange may be disposed lying transverse to and extending axially from the longitudinal axis 64 of the radiator body 58. As shown in FIG. 8, a vibration source 12 (including an electronic motor 68 coupled to an offset weight 70 by a shaft 72) may be operatively coupled to the radiator body 58 and a power source 16 (including two rechargeable batteries 74) operatively coupled to the vibration source 12. In addition, a controller 14 may be disposed in operative communication with the vibration source 12 in order to send a control signal to the vibration source 12 in order to emit vibration energy having characteristics as specified by a user.

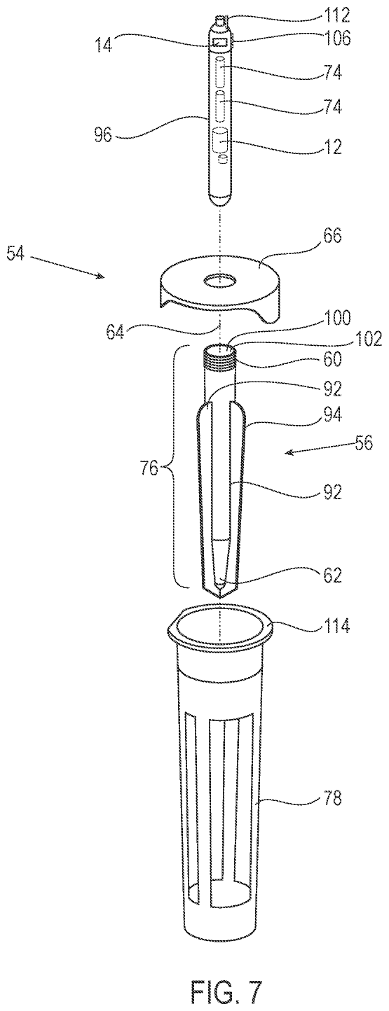

It may be desirable for an axial length 76 of the radiator body 58 as shown in FIG. 7 to be sufficient for the radiator body 58 to be disposed within the infusion mixture 26 disposed in the brewing system as shown in FIG. 8. In some cases, the axial length 76 of the radiator body is about 10 cm to about 50 cm. In addition, given the working environment of the agitator 54, it may also be desirable for a material of the radiator body to be liquid impermeable and thus the entire radiator body itself to be liquid impermeable. Suitable materials for the radiator body 58 and flange 66 may include polymers such as polycarbonate, ABS, silicone or the like, or metals such as stainless steel, copper or the like.

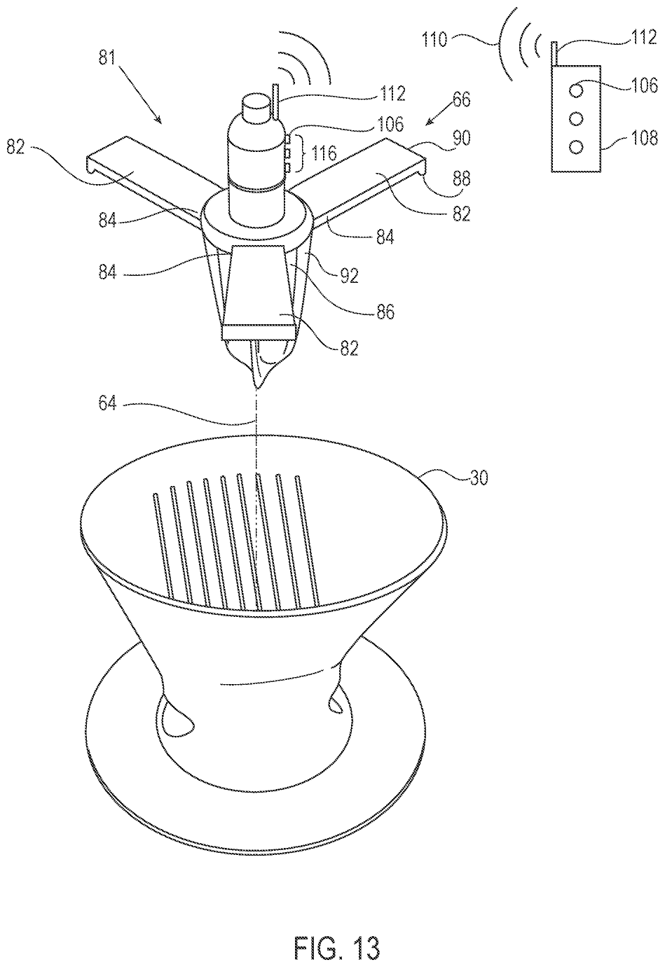

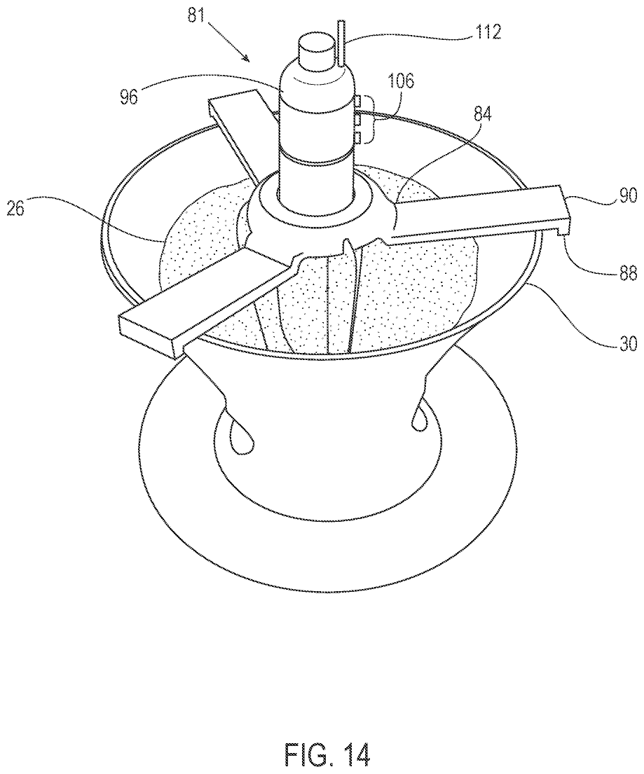

As shown in the embodiment of FIGS. 6-12, the flange 66 is substantially planar and disposed substantially perpendicular to the longitudinal axis 64 of the radiator body 58. The flange 66 is sized to cover an upper opening of a filter container 78 of a brewing system into which the radiator 56 is to be inserted during an infusion process. In some cases, a transverse dimension of the flange 66 may be at least as great as a transverse outer dimension of an upper opening of a filter container 78 of a brewing system. In addition, some flange embodiments 66 further include a lip 80 secured to and extending distally from the flange 66. Such a lip 80 may have a transverse dimension or span sufficient to cover a transverse outer dimension of an upper opening of a filter container 78 into which the radiator 56 is to be inserted during an infusion process. In some agitator embodiments 81, as shown in FIGS. 13-14, the flange 66 may include a plurality of radial extensions 82. Such radial extensions 82 may be resiliently rigid and have an inner end 84 secured to the radiator body 56 and extend radially outward therefrom. The plurality of rigid radial extensions 82 may be substantially perpendicular to the longitudinal axis 64 of the radiator body 86 as shown, but may have other suitable configurations in other cases.

The radial extensions may also include a lip 88 that extends distally from an outward end 90 of one or more of the radial extensions 82. The agitator embodiment 81 shown in FIGS. 13 and 14 may include some or all of the features, dimensions or materials as those of the agitator embodiment 54 shown in FIGS. 6-12. However, the agitator 81 of FIGS. 13 and 14 is generally configured to have a radiator body 86 that is shorter in axial length than the radiator body 58 of agitator 54. Such a shorter configuration may be useful for engaging an infusion mixture 26 disposed within a pour over type filter container 30 as opposed to a cold brew type filter container 78. For some embodiments, the axial length of the radiator body 86 of the agitator 81 may be about 5 cm to about 12 cm, more specifically, about 6 cm to about 10 cm. It should also be noted that the radial extensions 82 of the agitator embodiment 81 in FIGS. 13 and 14 and their associated structures may also be used in place of the flange 66 and its associated structures in the agitator embodiment of FIGS. 6-12, and vice versa.

In some cases, it may be useful to include additional planar type surfaces extending from the radiator 56 in order to more efficiently couple emitted vibration energy from the vibration source 12 to the infusion mixture 26 disposed about the radiator 56. As such, one or more elongate fins 92 may be secured to and extend radially from the radiator body 58. As illustrated in the embodiment of FIGS. 6-14, the fins 92 are substantially planar, evenly spaced about a circumference of the radiator 56, and extend longitudinally parallel to the longitudinal axis 64 of the radiator body 56. For some embodiments, a dimension of a radial extension of the fins 92 from a nominal surface 104 of the radiator body 56 to an outer extremity 94 of the fins 92 may be about 5 mm to about 50 mm.

In some instances, in order to effectively service or clean the agitator 54, and particularly the radiator body 56, it may be desirable to have the option of easily removing the electrical components, including the vibration source 12, power source 16 and controller 14 from the radiator body 56. As such, for some embodiments, the vibration source 12, power source 16 and controller 14 may be disposed within an enclosure 96 which has an outside surface 98 that is sized so as to be removably inserted into a proximal opening 100 of a lumen of the radiator. Once the enclosure 96 is so inserted, the vibration source 12 may be in operative communication with the radiator 56 so as to effectively couple vibration energy emitted from the vibration source 12 to an outside surface 104 of the radiator 56.

In order for a user of the agitator 54 to effectively achieve a desired enhancement and control of an infusion process, the controller 14 of the agitator 54 may include a variety of features that allow the user to customize delivery of vibration energy to the infusion mixture of the user's choice. Generally speaking, for the agitator embodiment 54 shown in FIGS. 6-14, the power source 16 may be in operative communication with the controller 14, the vibration source 12 or both the controller 14 and vibration source 12. In some cases, the controller 14 may be configured to control the vibration energy duration, vibration energy intensity, vibration energy displacement, and/or frequency of emitted vibration energy. In addition, the controller 14 may be configured to produce intermittent vibration over a scheduled time period or multiple time periods or a schedule of vibration energy delivery generally. In order for a user to enter the desired vibration energy parameter, the controller 14 may include one or more user interface buttons 106 configured to adjust vibration energy parameters.

In some instances, the controller may be configured for a user to use at least one of the interface buttons 106 to select a vibration energy power level from pre-selected levels or a range of vibration energy power, including low power, medium power and high power, for example. In addition, the controller may be configured for a user to select a duration of vibration energy emission using one or more of the interface buttons 106 for a time of between 1 minute and 60 minutes for some embodiments. For some embodiments, the controller may be configured for a user to use one or more of the interface buttons 106 to select a duration of vibration energy emission from a pre-selected menu of vibration energy durations including 1 minute, 5 minutes and 10 minutes, or any other suitable pre-selected duration value. One or more of the interface buttons 106 may further be used to select a time schedule, such as an intermittent time schedule for the emission of vibration energy from the agitator 54 to an infusion mixture 26 in contact with the agitator 54.

For convenient control and use, the controller 14 of some agitator embodiments 54 may be configured to be in wireless communication with a remote controller 108. For example, in some cases, such a remote controller 108 may include a smart phone application that a user may install on their existing equipment if so desired. In other cases, the remote controller 108 may include a separate wireless controller. Such a remote controller 108 may emit a control signal 110 that includes vibration energy emission information to the controller 14 disposed adjacent the vibration source 12, which in some cases may be referred to as the “primary” controller 14. For such embodiments, both the primary controller 14 and remote controller 108 may include a signal emitter, such as an antenna 112, in order to communicate their respective signals to each other.

In order to provide a desired level of infusion enhancement and control, it may be useful for some vibration source embodiments to emit vibration energy having particular characteristics. For some embodiments, the vibration source 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be configured to produce vibration energy having a vibration acceleration of about 4 m/s2 to about 60 m/s2, a vibration speed of about 7 mm/s to about 55 mm/s, and a vibration displacement of about 0.08 mm to about 0.7 mm. For such embodiments, the controller 14 may be configured to provide a control signal 110 to the vibration source 12 to emit vibration energy having any of these vibration energy parameters. Vibration energy parameters such as these are also shown in the chart of FIG. 19 and controller embodiments 14 may be configured to produce any combination of the vibration energy parameters shown in the chart of FIG. 19 or any other suitable vibration energy parameters.

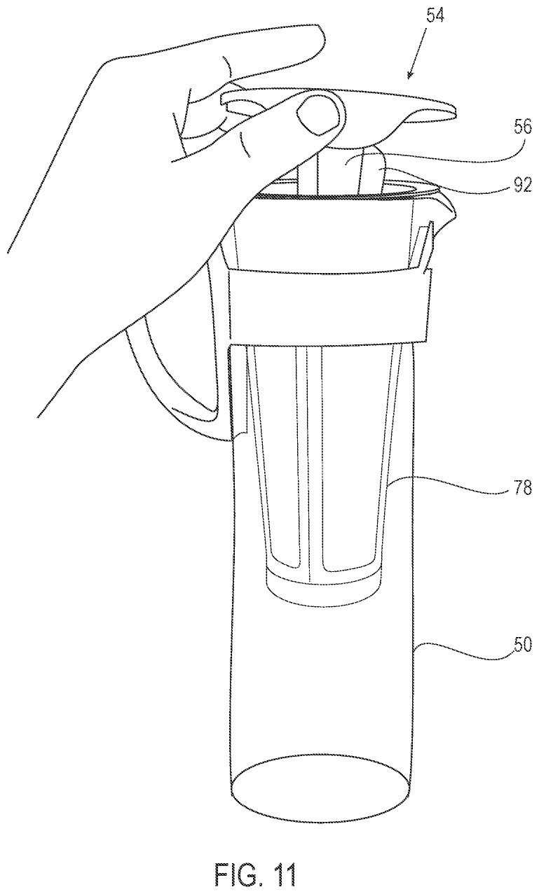

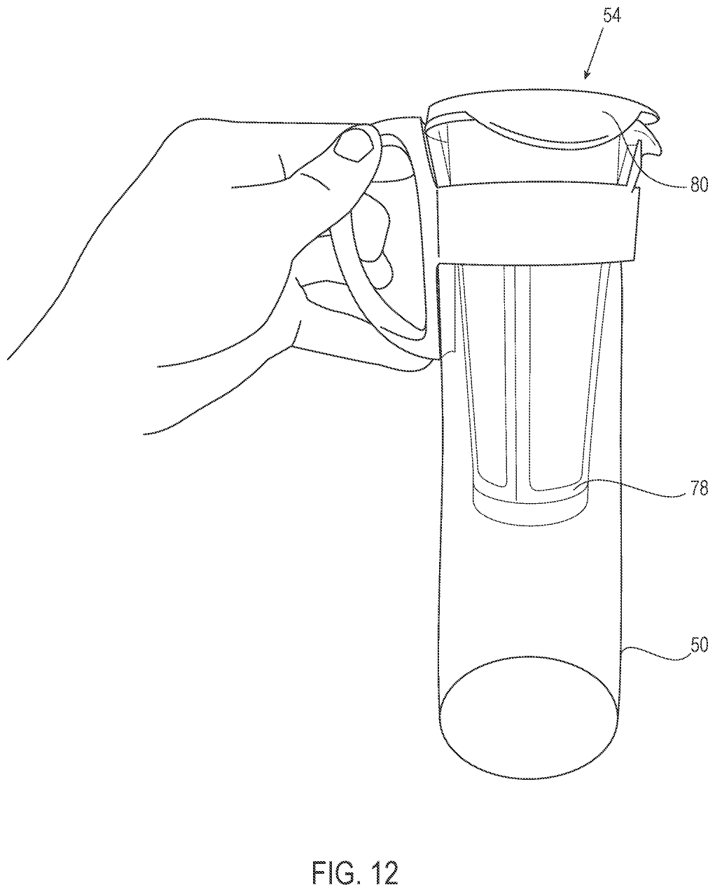

In use, some method embodiments for enhancing infusion of a liquid may include inserting a radiator 56 of an agitator 54 into an infusion mixture 26 as shown in FIGS. 11 and 12 and selecting vibration energy emission characteristics and inputting these characteristics into a controller 14 of the agitator 54. The method may further include emitting vibration energy having the selected vibration energy emission characteristics from a vibration source 12 of the agitator 54 into the infusion mixture in order to control and enhance an infusion process.

For the agitator embodiments 54 that include a flange secured to the radiator 56 adjacent the proximal end of the radiator body 58 as discussed above, inserting the radiator 56 into the infusion mixture 26 may further include inserting the radiator 56 into the infusion mixture 26 until the flange 66 contacts and rests upon an upper edge 114 of a container 78 that contains the infusion mixture 26. Such an arrangement can help stabilize the vertical position of the agitator 54 relative to the container 78 that holds the infusion mixture 26. The flange 66, in some cases, may also serve to cover the infusion mixture 26 during the infusion process. For flange embodiments 66 that include a lip 80 secured to and extending distally from the flange 66, inserting the radiator 56 into the infusion mixture 26 may further include inserting the radiator 56 into the infusion mixture 26 until the lip 80 overlaps and is disposed about the upper edge 114 of the container 78 that contains the infusion mixture 26. Such a lip structure 80 may serve to further stabilize the position of the agitator 54 and radiator 56 thereof after insertion of the radiator 56 into the infusion mixture 26 and during the infusion process.

For agitator embodiments that include a removably insertable enclosure 96 that houses the vibration source 12, power source 16, and/or controller 14, the method of using the agitator 54 may further include inserting the enclosure 96 into the lumen 102 of the radiator 56 such that the vibration source 12 is in operative communication with the radiator 56 as discussed above. In addition, the enclosure 96 may be withdrawn from the lumen 102 of the radiator body 58 in order to clean the device or service the components within the enclosure 96.

Once the radiator 56 of the agitator 54 has been operatively inserted into the infusion mixture 26, power may be supplied to the vibration source 12 from the power source 16 while a control signal 110 (which may be a wireless signal or an electrical signal transmitted through wires) is transmitted to the vibration source 12 such that vibration energy having characteristics chosen by the user may then be emitted into the infusion mixture 26 to achieve a desired level of infusion enhancement and control. The user may select the desired vibration energy parameters by entering the parameters into the controller 14 by means of a user interface 116 that may include one or more buttons 106 which may be depressed or otherwise actuated by the user in order to program or otherwise instruct the controller 14 to produce the appropriate control signal 110 and transmit that control signal 110 to the vibration source 12 during the infusion process. For convenient control and use, as discussed above, the controller 14 of some agitator embodiments 54 may be configured to be in wireless communication with a remote controller 108. For example, in some cases, such a remote controller 108 may include a smart phone application that a user may install on their existing equipment if so desired. In other cases, the remote controller may include a separate wireless controller. For such embodiments, the entry of vibration energy parameters by a user may include entering vibration energy parameters into the remote controller 108 by depressing buttons 106 or the like of the remote controller 108. The remote controller 108 will then transmit a control signal 110 to the controller 14 which is adjacent the vibration source (which, in this case, may be referred to as a primary controller). The primary controller 14 then transmits the corresponding control signal, which may be an electrical signal over a wired connection 22 in some cases, to the vibration source. For such embodiments that include remote controllers 108, and particularly remote controllers 108 in the form of a smart phone application, it may be useful for the remote controller 108 to be programmable to store a particular set of vibration energy parameters and timing schedule as a “recipe” for infusion enhancement and control. In this way, the user may simply select a stored infusion recipe as a shortcut for repeating previously used regimens that the user wants to repeat.

As discussed above, during the infusion process, the controller 14 may control any one or more of vibration duration, vibration displacement, vibration frequency, and vibration schedule. In some cases, selecting vibration energy emission characteristics and inputting these characteristics into the controller of the agitator 54 include selecting a vibration power level from pre-selected levels of vibration power, including low power, medium power and high power. In some cases, selecting vibration energy emission characteristics and inputting these characteristics into the controller 14 of the agitator 54 may include selecting a duration of vibration energy emission for a time of about 1 minute to about 60 minutes. In some cases, selecting vibration energy emission characteristics and inputting these characteristics into a controller of the agitator may include selecting a duration of vibration energy emission from a pre-selected menu of vibration energy emission durations including 1 minute, 5 minutes and 10 minutes. Once such parameters have been selected and inputted into the controller 14, the controller 14 may then generate a corresponding control signal 110 which is transmitted to the vibration source which in turn emits vibration energy having the selected parameters for the selected duration or durations.

In some cases, as discussed above, the controller 14 may be programmed by a user to generate a control signal 110 to the vibration source 12 resulting an emission of vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be programmed to produce vibration energy having a vibration acceleration of about 4 m/s2 to about 60 m/s2, a vibration speed of about 7 mm/s to about 55 mm/s, and a vibration displacement of about 0.08 mm to about 0.7 mm. Vibration energy parameters such as shown in the chart of FIG. 19 may be emitted by the vibration source 12 as a result of the transmission or a corresponding control signal 110 from the controller 14. The controller 14 may be further programmed to produce a control signal 110 transmitted to the vibration source 12 which produces any combination of the vibration energy parameters shown in the chart of FIG. 19 or any other suitable vibration energy parameters.

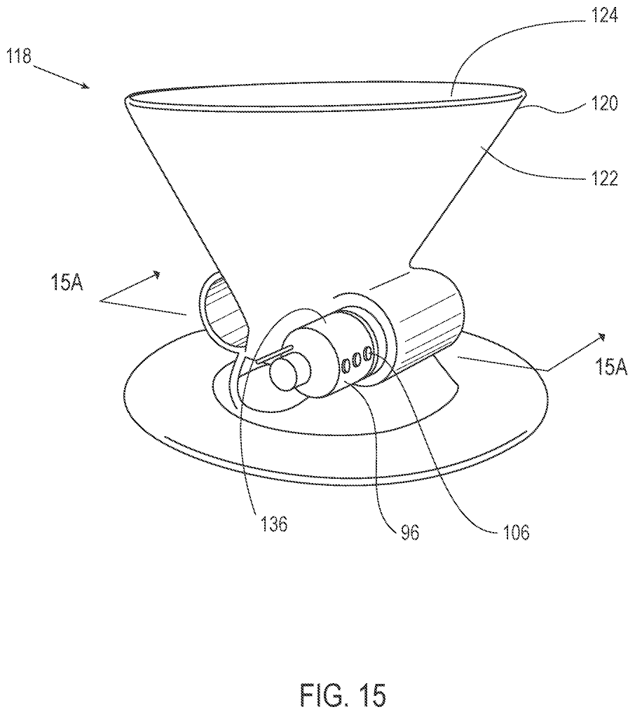

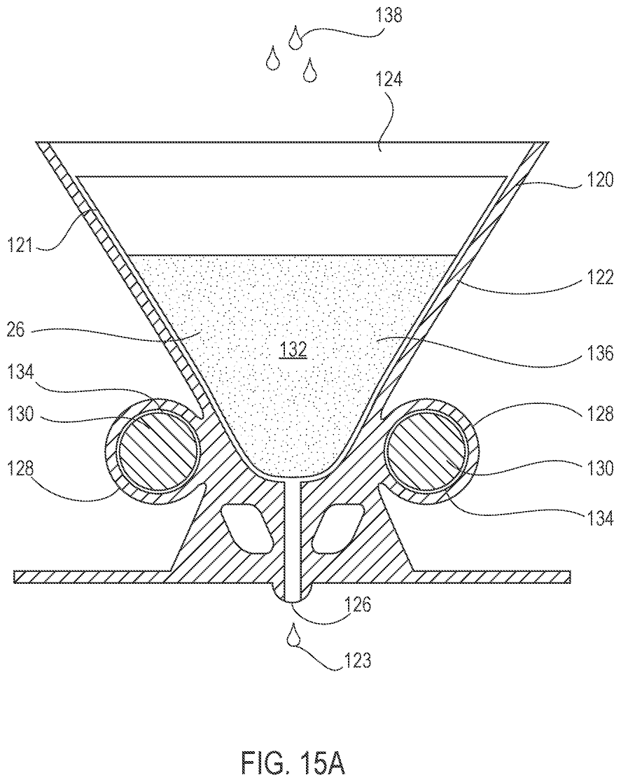

As discussed above, some agitator embodiments for enhancing infusion of a liquid may be configured to be integral with a brewing system or component thereof. Referring to FIGS. 15-15A, an agitator 118 includes a pour over type filter container 120 that may typically be used to hold a filter 121 in an open funnel shaped position and which may then be filled with a desired solid material (such as ground coffee or the like). A liquid such as water may then be poured over the solid material to infuse the water with the desired components of the solid material to generate in infused liquid 123 (such as coffee or the like). In some cases, a corresponding agitator embodiment may include a filter container 120 having a wall 122 with a funnel shaped contour, an upper opening 124, at least one lower opening 126 that is smaller than the upper opening 124 and at least one receptacle 128 as shown in FIGS. 15-15A. Such an agitator embodiment 118 may further include a modular agitator assembly 130 (which in some cases may be the same as or similar to the enclosure 96 and its associated components 12, 14, 16 discussed above), having a vibration source 12, a power source 16 operatively coupled to the vibration source 12, and a controller 14 in operative communication with the vibration source 12. In addition, the modular agitator assembly 130 may have an enclosure 96 herein the vibration source 12, power source 16 and controller 14 are disposed within the enclosure 96. Such an enclosure 96 may have an outer surface which is sized and configured to be removably inserted into the receptacle 128 (or optional dual receptacles 128 as shown in FIG. 15) with the vibration source 12 in operative communication with an interior volume 132 of the filter container 120. Such an arrangement may allow the vibration source 12 of the modular agitator assembly 130 to emit vibration energy having parameters tuned by a user into an infusion mixture 26.

For certain embodiments, the enclosure 96 may have a cylindrically shaped body and the receptacle 128, or plurality of receptacles 128, may have a cylindrically shaped orifice 134 sized to receive the outer surface 98 of the enclosure 96 with an interference type fit or any other suitable arrangement by which to releasably secure the modular agitator assembly 130 into the receptacle or receptacles 128. For such a pour over type agitator embodiment 118, a user would insert the modular agitator assembly or assemblies 130 into the cylindrically shaped orifice 134 such that each respective vibration source 12 is in operative communication with the wall 122 of the pour over type filter container 120 and any contents of the interior volume 132 of the filter container 120 such as an infusion mixture 26 disposed therein. A filter 121 may optionally be placed into the filter container 120 and then a desired solid material 136 may be placed into the interior of the filter 121. The vibration source 12 of the modular agitator assembly 130 may then be activated by a control signal 110 from the controller 14 with power to the vibration source being supplied by the power supply 16 (see FIG. 8). The vibration source 12 may then emit vibration energy into the interior volume 132 of the filter container 120 as a liquid 138 is being poured over the solid material 136 in the filter 121 during the infusion process. The controller 14 may be programmed to provide a control signal 110 corresponding to any of the vibration energy parameters of any of the agitator embodiments discussed above in order to carry out the desired enhancement and control of the infusion process.

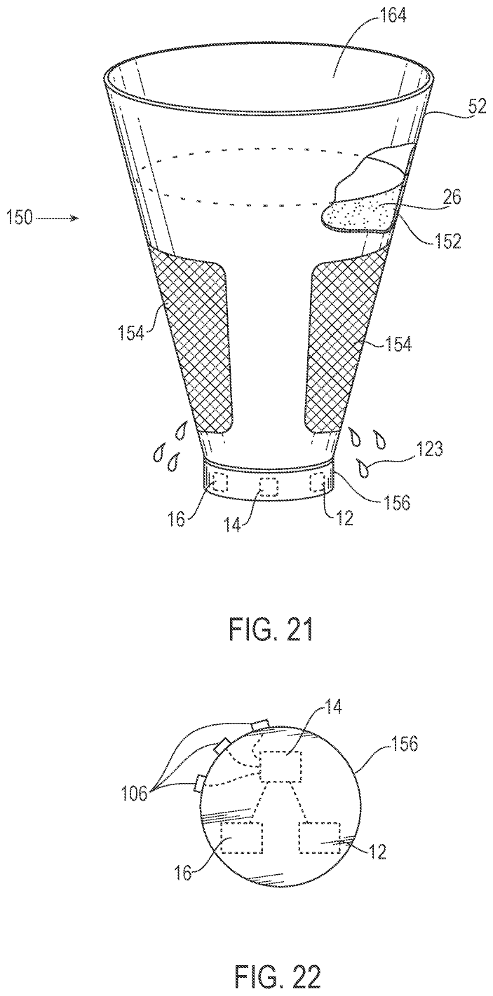

FIGS. 21 and 22 show an agitator embodiment 150 with the vibration source 12 being disposed at the bottom of the filter container basket 30. Alternatively, the vibration source 12 may be disposed in a separate self-contained hollow “puck” that is waterproof and may be placed in a bottom of an interior volume of the filter container basket 30. The controller 14 may include a wireless configuration or run via a wire up through an interior cavity of the filter container basket 30. Some embodiments of an agitator for enhancing infusion of a liquid, may include the filter container 30, including a wall 152 disposed about an interior cavity, a filter portion 154 disposed on the wall 152 including a plurality of passages that allow the passage of liquid but prevent the passage of solid ground material 136 as found in the infusion mixture 26. The agitator 150 may also include a base 156 secured to a bottom of the filter container 30, the vibration source 12 operatively coupled to the base 156, a power source 16 operatively coupled to the vibration source 12 and the controller 14 in operative communication with the vibration source 12.

In some instances, the base 156 may include a hollow configuration with a sealed interior volume and the vibration source 12, power source 16 and controller 14 may be disposed within the sealed interior volume of the base 156. As discussed above, for some embodiments, the base 156 may be configured as a waterproof and heatproof puck that is a separate stand alone device that is not secured to the filter container basket 30. For such an embodiment, the vibration source 12 (and optionally the controller 14 and power source 16) may be disposed within the base 156 with the outside dimensions of the base 156 selected to allow the base to be placed in the bottom or any other suitable location within the interior cavity of the filter container basket 30. For the agitator embodiment 150, elements such as the vibration source 12, controller 14 and power source 16 may have features, dimensions and materials which are the same as or similar to those of the vibration source 12, controller 14 and power source 16 discussed above. The same holds true for any other elements that have the same reference numbers as those discussed above.

In order for a user of the agitator 150 to effectively achieve a desired enhancement and control of an infusion process, as discussed above with regard to other agitator embodiments, the controller 14 of the agitator 150 may include a variety of features that allow the user to customize delivery of vibration energy to the infusion mixture of the user's choice. Generally speaking, for the agitator embodiment 150 and any other suitable agitator embodiment discussed herein, the power source 16 may be in operative communication with the controller 14, the vibration source 12 or both the controller 14 and vibration source 12. In some cases, the controller 14 may be configured to control the vibration energy duration, vibration energy intensity, vibration energy displacement, and/or frequency of emitted vibration energy. In addition, the controller 14 may be configured to produce intermittent vibration over a scheduled time period or multiple time periods or a schedule of vibration energy delivery generally. In order for a user to enter the desired vibration energy parameter, the controller 14 may include one or more user interface buttons 106 (see FIGS. 6 and 22 for example) configured to adjust vibration energy parameters.

In some instances, the controller 14 may be configured for a user to use at least one of the interface buttons 106 to select a vibration energy power level from pre-selected levels or a range of vibration energy power, including low power, medium power and high power, for example. In addition, the controller may be configured for a user to select a duration of vibration energy emission using one or more of the interface buttons 106 for a time of between 1 minute and 60 minutes for some embodiments. For some embodiments, the controller may be configured for a user to use one or more of the interface buttons 106 to select a duration of vibration energy emission from a pre-selected menu of vibration energy durations including 1 minute, 5 minutes and 10 minutes, or any other suitable pre-selected duration value. One or more of the interface buttons 106 may further be used to select a time schedule, such as an intermittent time schedule for the emission of vibration energy from the agitator 150 to an infusion mixture 26 in contact with the agitator 150.

For some agitator embodiments 150, the controller 14 or any other suitable portion of the agitator 150 may include a user interface that includes a first switch that may be used to toggle through a plurality of predetermined vibration power levels. For example, in some cases, such a first switch, that may include a waterproof button 106 that is responsive to finger pressure, may be depressed in order to toggle between a first power level, a second power level, a third power level, a fourth power level and a fifth power level, with each of these power levels being different from the others. In some cases, the first power level represents the lowest power level and the fifth power level represents the highest power level, with the second power level through fourth power levels representing corresponding intermediate power level values. Although some embodiments include the five power levels discussed above, any suitable number of discrete power levels may be used including 6, 7, 8, 9 10 or more power levels which may be selected by a single power level switch or multiple power level switches. It should be noted that varying the vibration energy output by the vibration source 12 at the various power levels may be carried out by configuring the controller 14 to generate varying rotation speed of a motor 68 having an offset weight 70 disposed on the output shaft 72 thereof for such a vibration source embodiment 12 as shown in FIG. 8, for example.

For some such agitator embodiments 150, the controller 14 or any other suitable portion of the agitator 150 may include the user interface with a second switch that may be used to toggle through a plurality of predetermined vibration duration periods. For example, in some cases, such a second switch, that may include a waterproof button 106 that is responsive to finger pressure, may be depressed in order to toggle between a first predetermined vibration period, a second predetermined vibration period, a third predetermined vibration period, a fourth predetermined vibration period and a fifth predetermined vibration period, with each of these vibration periods being different from the others. In some cases, the first vibration period may represent the shortest vibration period and the fifth vibration period may represent the longest vibration period, with the second vibration period through fourth vibration period representing corresponding intermediate vibration period values. Although some embodiments may include the five vibration periods discussed above, any suitable number of discrete vibration periods may be used including 6, 7, 8, 9 10 or more vibration periods which may be selected by a single vibration period switch 106 or multiple vibration period selection switches.

It should be noted that a range of the vibration period durations may be set differently for different processes. For example, for cold brewing, the first vibration period may be set to about 1 hour, the second vibration period about 2 hours, the third vibration period about 4 hours, the fourth vibration period about 9 hours or more including 18 hours and the fifth vibration period may optionally include a programmable vibration period pattern and/or vibration period that may be controlled remotely such as by a smart phone application or separate remote control device. For some embodiments that are being used for hot brewing, the first vibration period may be set to about 1 minute, the second vibration period about 2 minutes, the third vibration period about 3 minutes, the fourth vibration period about 4 minutes and the fifth vibration period may optionally include a programmable vibration period pattern and/or vibration period that may be controlled remotely such as by a smart phone application or separate remote control device.

In some cases, the controller 14 may also include a speaker (not shown) which is operatively coupled thereto. Such a speaker may be disposed at any suitable position on the agitator embodiment 150 and may include a waterproof speaker in some cases. Such a speaker may also be configured to emit a tone or other audio signal that may alert a user of the agitator 150 to a variety of processes being carried out by the agitator 150. For example, the controller 14 may be configured to emit a tone from the speaker to indicate the passage of time, to indicate completion of a brew cycle including completion of a preselected vibration period, to indicate when vibration energy output has been enabled or disabled and the like. A temperature sensor (not shown) may also be disposed on the agitator embodiment 150 in any suitable position and may be operatively coupled to the controller 14 in order to provide brew temperature data to the controller 14.

For convenient control and use, the controller 14 of some agitator embodiments 150 may be configured to be in wireless communication with a remote controller 108 as shown on the embodiments of FIGS. 6 and 13. For example, in some cases, such a remote controller 108 may include a smart phone application that a user may install on their existing equipment if so desired. In other cases, the remote controller 108 may include a separate wireless controller. Such a remote controller 108 may emit a control signal 110 that includes vibration energy emission information to the controller 14 disposed adjacent the vibration source 12, which in some cases may be referred to as the “primary” controller 14. For such embodiments, both the primary controller 14 and remote controller 108 may include a signal emitter, such as an antenna 112, in order to communicate their respective signals to each other.

In order to provide a desired level of infusion enhancement and control, it may be useful for some vibration source embodiments to emit vibration energy having particular characteristics. For some embodiments, the vibration source 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be configured to produce vibration energy having a vibration acceleration of about 4 m/s2 to about 60 m/s2, a vibration speed of about 7 mm/s to about 55 mm/s, and a vibration displacement of about 0.08 mm to about 0.7 mm. For such embodiments, the controller 14 may be configured to provide a control signal 110 to the vibration source 12 to emit vibration energy having any of these vibration energy parameters. Vibration energy parameters such as these are also shown in the chart of FIG. 19 and controller embodiments 14 may be configured to produce any combination of the vibration energy parameters shown in the chart of FIG. 19 or any other suitable vibration energy parameters. For example, for some embodiments, the vibration source 12 may emit vibration energy having a frequency of about 1 Hz to about 10,000 Hz in some cases, about 1 Hz to about 1000 Hz in some instances.

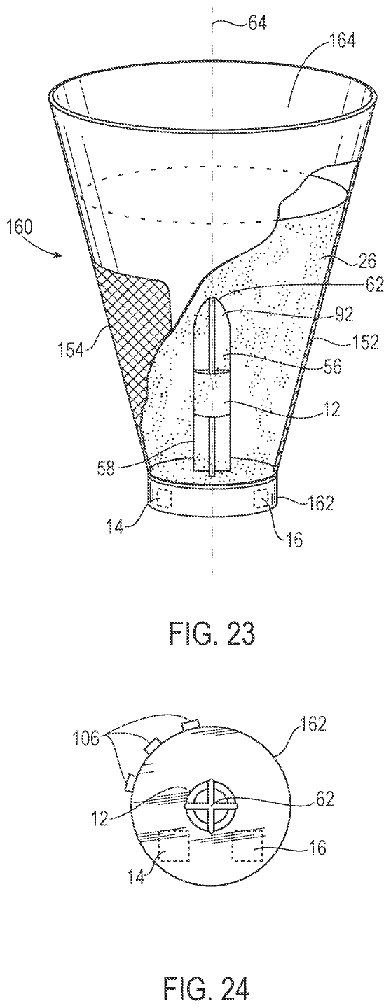

In some cases, it may be desirable to increase a surface area of a surface that couples vibrational energy from the vibration source 12 to the infusion mixture 26. An agitator embodiment 160 including a cold brew ground basket 30 with a “dart” shaped radiator 56 pointing up into an interior of the basket 30 is shown in FIG. 23. The upward orientation of the radiator 56 may be useful in some cases to facilitate filling the basket 30 with solid grounds 136 and liquid through the upper opening of the pour over filter basket 30. For such embodiment, the radiator 56 may be secured to and extend upward from a base 162 into an interior cavity 164 of the pour over filter container 30. The radiator 56 may include a radiator body 58 having an elongate outer contour, a proximal end 60, a distal end 62 and a longitudinal axis 64. In general, the features, dimensions and/or materials of the agitator embodiment 160 may be the same as or similar to the features, dimensions and/or materials of the agitator embodiment 150 discussed above except for the inclusion of the radiator 56 and associated structures extending upward into the interior of the basket 30. In addition, for some such embodiments 160, the vibration source 12 may be disposed on the radiator 56 itself as shown in FIG. 23 wherein the vibration source 12 is disposed at approximately the axial mid-point of the radiator 56.

In some instances, an axial length of the radiator body may be about 10 cm to about 50 cm. In some cases, the radiator body 58 may be liquid impermeable and further include one or more elongate fins 92 which may be secured to and extend radially from the radiator body 58. In some instances, the fins 92 may be substantially planar and a dimension of a radial extension of the fins 92 from a nominal surface of the radiator body 58 to an outer extremity of the fins 92 may be about 5 mm to about 50 mm. For the agitator embodiment 160, elements such as the vibration source 12, controller 14 and power source 16 may have features, dimensions and materials which are the same as or similar to those of the vibration source 12, controller 14 and power source 16 discussed above. The same holds true for any other elements of agitator embodiment 160 that have the same reference numbers as those discussed above.

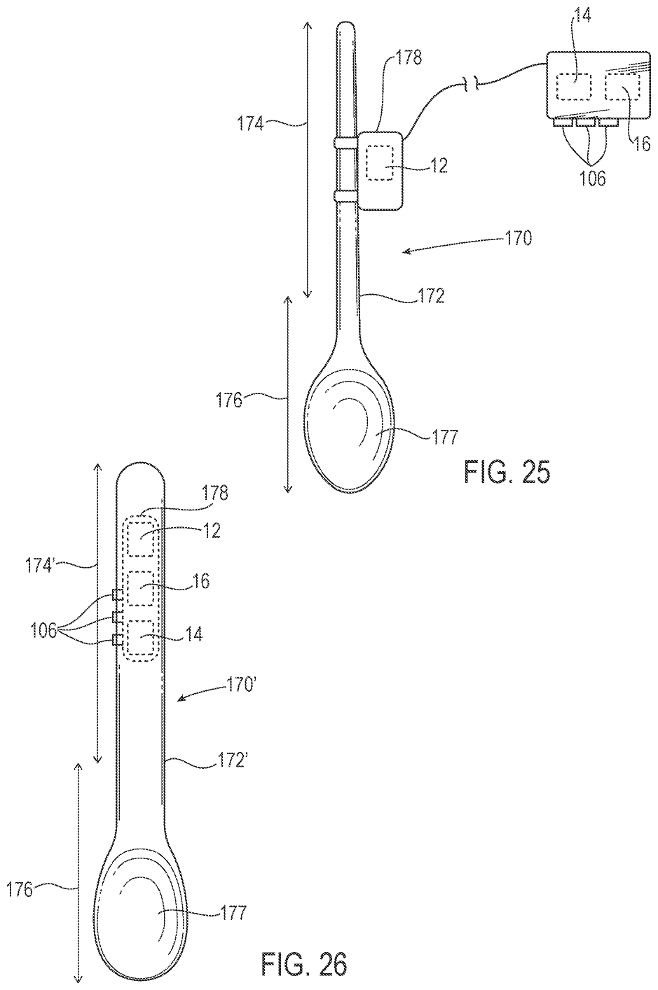

In some cases, a portable agitator embodiment that is compatible for use within any container that has an open top configuration and that contains the infusion mixture 26 may be useful. FIGS. 25-26 show agitator embodiments having a spoon or wand type configuration (or any other suitable configuration) that includes the vibration source 12. Such embodiments may be placed in pour over, cold brew grounds, immersion style brewers such as a French press or the like and activated to emit vibration energy during the brewing process. In particular, some embodiments of an agitator 170 for enhancing infusion of a liquid, may include an elongate stirring wand 172 including a proximal handle section 174 and a stir section 176 that extends distally from the proximal handle section 174. In some cases, the stirring wand 172 may include a convex spoon tip 177 secured to a distal end of the stir section 176. For some embodiments, an axial length of the elongate stirring wand 172 may be about 10 cm to about 50 cm.

The vibration source 12 may be operatively coupled to the elongate stirring wand 172 with a power source 16 operatively coupled to the vibration source 12 and the controller 14 in operative communication with the vibration source 12. In some cases, the elongate stirring wand 172 may include a hollow housing 178 with a sealed interior volume and the vibration source 12, power source 16 and controller 14 may be disposed within the interior volume of the hollow housing 178. In some cases, the vibration source 12 and housing 178 may be releasably secured to the proximal handle section 174, such as is shown in the agitator embodiment 170 in FIG. 25. For other embodiments, the vibration source 12, power source 16 and controller 14 may be disposed within the housing 178 which may in turn be disposed within a nominal ergonomic contour of the proximal handle section 174′ of the wand 172′ of the agitator embodiment 170′ of FIG. 26. For the agitator embodiments 170, 170′, elements such as the vibration source 12, controller 14 and power source 16 may have features, dimensions and materials which are the same as or similar to those of the vibration source 12, controller 14 and power source 16 discussed above. The same holds true for any other elements of agitator embodiments 170, 170′ that have the same reference numbers as those discussed above.

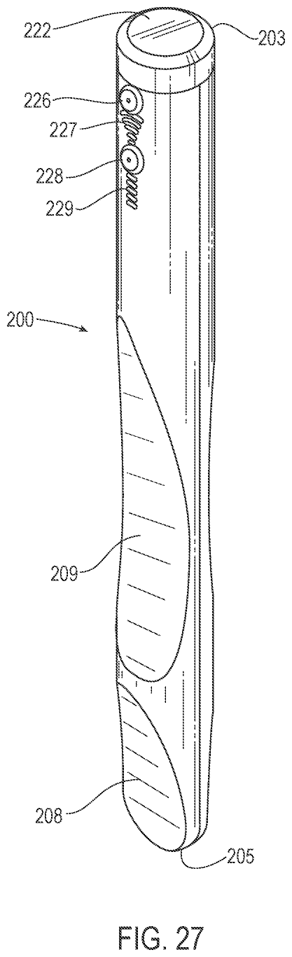

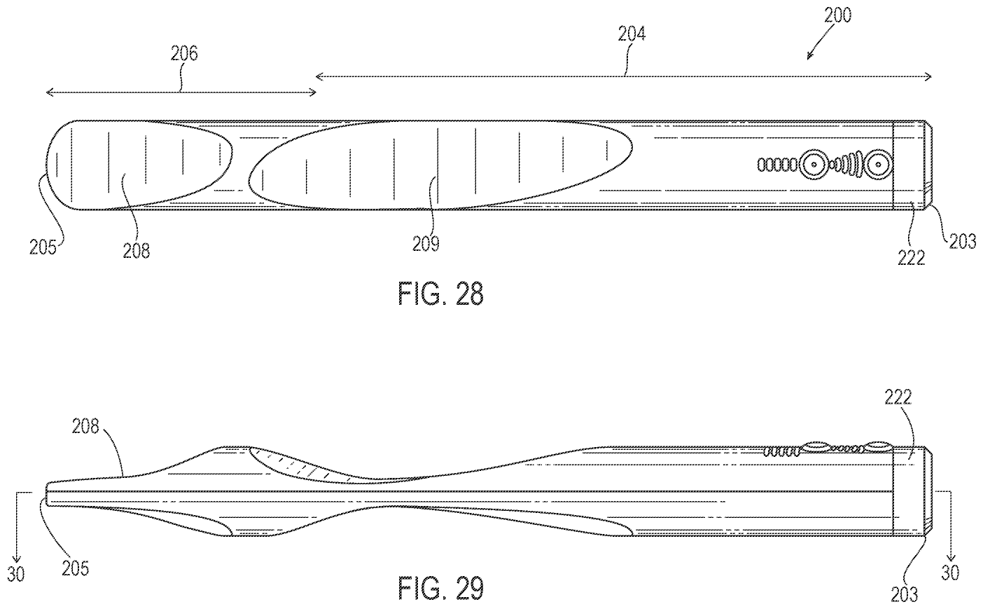

FIGS. 27-35 show another agitator embodiment 200 having a spoon or wand type configuration that includes the vibration source 12 that may be disposed in or near a distal section thereof. As discussed above, such embodiments may be placed into operative contact with pour over grounds, cold brew grounds, infusion mixtures 26 disposed in immersion style brewers such as a French press or the like and activated to emit vibration energy into the infusion mixture 26 during the brewing process. The spoon shaped agitator 200 for enhancing infusion of a liquid, may include an elongate stirring wand 202 including a proximal end 203, a distal end 205, a proximal handle section 204 and a stir section 206 that extends distally from the proximal handle section 204 as shown in FIG. 28. The proximal handle section 204 is a longitudinal section of the stirring wand 202 that is practical to grip by a user during delivery of vibration energy from the agitator 200 to an infusion mixture 26 during use. The stir section 206 is a section of the stirring wand 202 that extends distally from a distal end of the proximal handle section 204 and may include a spoon tip 208. In some cases, the spoon tip 208 may be disposed at a distal end of the stir section 206.

In some instances, the spoon tip 208 may optionally include a convex shape and may also optionally have an enlarged transverse dimension relative to a transverse dimension of the proximal handle section 204 disposed adjacent the spoon tip 208 such as is shown in the agitator embodiments 170 and 170′ discussed above. In addition, the spoon tip 208 may also include optional holes, slots or any other feature (not shown) that may enhance the movement of the spoon tip 208 through the infusion mixture 26 or enhance a transfer of vibration energy from the spoon tip 208 to the infusion mixture disposed about the spoon tip 208. For some embodiments, an axial length of the elongate stirring wand 202 may be about 10 cm to about 50 cm for some embodiments, about 10 cm to about 20 cm for some embodiments, and about 20 cm to about 35 cm for some embodiments. The longer embodiments of the elongate stirring wand 202 may be particularly useful for enhancing an infusion process in a French press or cold brew press in some cases.

The vibration source 12 may be operatively coupled to the elongate stirring wand 202 at or near a distal section thereof with a power source 16 operatively coupled to the vibration source 12 and the controller 14 in operative communication with the vibration source 12. In some cases, the elongate stirring wand 202 may include a hollow housing 210 with a housing wall 211 with a sealed interior volume and the vibration source 12, power source 16 and controller 14 may be disposed within the interior volume of the hollow housing 210. The hollow housing 210 may include a generally elongate cylindrical shape extending from the proximal end 203 of the stirring wand 202 to the distal end 205 of the stirring wand 202. For some embodiments, the general cylindrical configuration may be interrupted by structures such as the spoon tip 208 disposed at a distal end 205 of the stirring wand 202 and a thinned section 209 of the hollow housing 210 disposed on the proximal handle section 204 of the stirring wand 202.

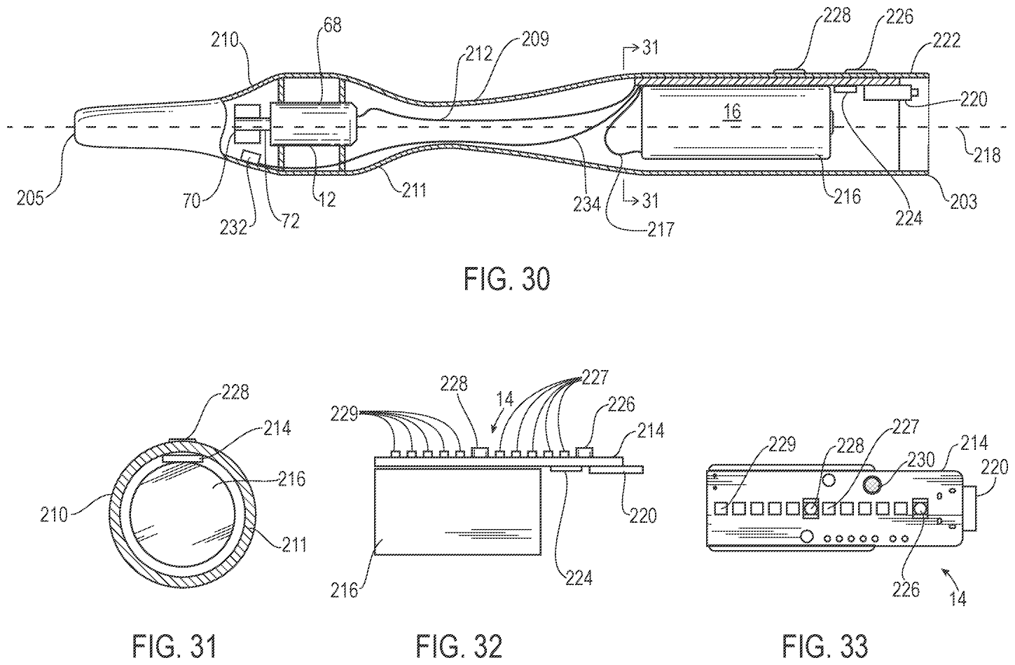

For some agitator embodiments 200, the vibration source 12, power source 16 and controller 14 may be disposed within the housing 210. As discussed above, the vibration source 12 may optionally be disposed within and secured in fixed relation to a distal section of the housing 210 with any suitable structure such as molded gussets as shown or the like. The controller 14 and power source 16 may optionally be disposed within and secured in fixed relation to a nominal ergonomic contour of the proximal handle section 204 of the wand 202 of the agitator embodiment 200 as shown in FIG. 30. For the agitator embodiments 200, elements such as the vibration source 12, controller 14 and power source 16 may have features, dimensions and materials which are the same as or similar to those of the vibration source 12, controller 14 and power source 16 discussed above.

For example, for convenient control and use, the controller 14 of some agitator embodiments 200 may be configured to be in wireless communication with a remote controller 108 as shown on the embodiments of FIGS. 6 and 13 discussed above. For example, in some cases, such a remote controller 108 may include a smart phone application that a user may install on their existing equipment if so desired. In other cases, the remote controller 108 may include a separate wireless controller. Such a remote controller 108 may emit a control signal 110 that includes vibration energy emission information to the controller 14, which in some cases may be referred to as the “primary” controller 14. For such embodiments, both the primary controller 14 and remote controller 108 may include a signal emitter, such as an antenna 112, in order to communicate their respective signals to each other.

For some embodiments, in order to provide a desired level of infusion enhancement and control, it may be useful for some vibration source embodiments to emit vibration energy having particular characteristics. For some embodiments, the vibration source 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be configured to produce vibration energy having a vibration acceleration of about 4 m/s2 to about 60 m/s2, a vibration speed of about 7 mm/s to about 55 mm/s, and a vibration displacement of about 0.08 mm to about 0.7 mm. For such embodiments, the controller 14 may be configured to provide a control signal, such as, for example, control signal 110 discussed above, to the vibration source 12 to emit vibration energy having any of these vibration energy parameters. Vibration energy parameters such as these are also shown in the chart of FIG. 19 and controller embodiments 14 may be configured to produce any combination of the vibration energy parameters shown in the chart of FIG. 19 or any other suitable vibration energy parameters.

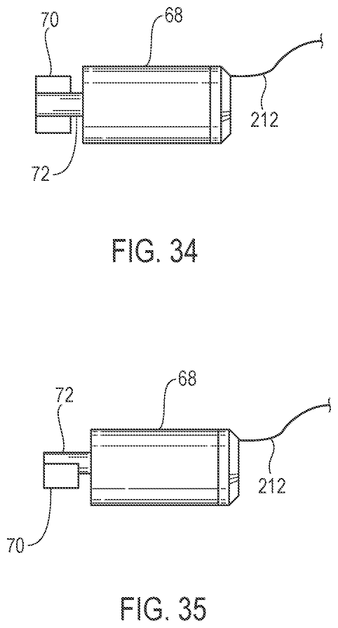

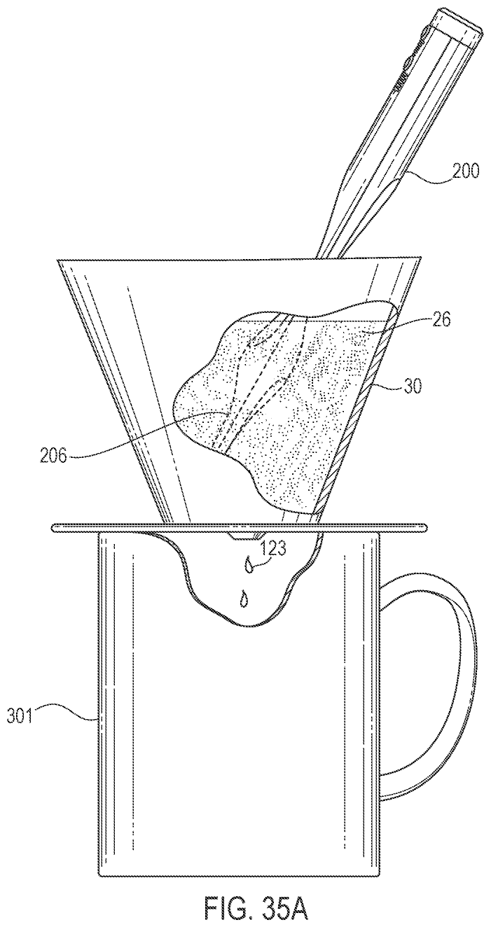

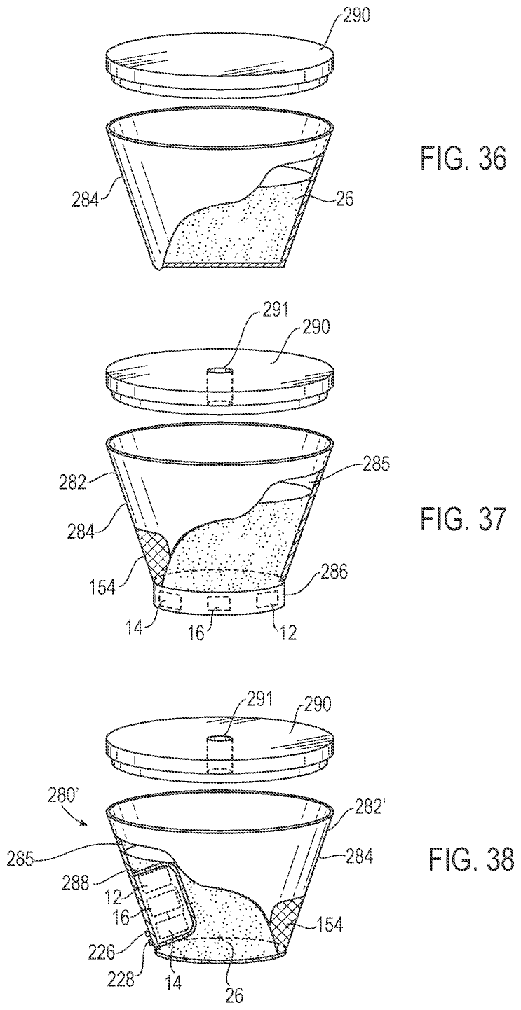

For the agitator embodiment 200 shown in FIGS. 27-35, the vibration source may include the electric motor 68 coupled to an offset weight 70 by a shaft 72 as shown in FIG. 30 and also in FIGS. 34 and 35. In some cases, it may be advantageous to have the electric motor 68 and offset weight 70 disposed in a distal section of the stirring wand 202. For some embodiments, it may be useful to have the electric motor 68, and particularly the offset weight 70 which is coupled to the shaft 72 of the electric motor 68, of the vibration source 12 disposed in a distal most 25 percent of the stirring wand 202 along a longitudinal axis 218 of the stirring wand 202. Although the electric motor 68 and offset weight 70 may be disposed in any suitable position within the hollow cavity of the hollow housing 210, it may be useful for the efficient transfer of vibration energy from the vibration source 12 to have the offset weight 70 of the vibration source 12 disposed in the distal most 25 percent of the stirring wand 202 adjacent the spoon tip 208, in some cases. For some embodiments, it may be useful to have the electric motor 60 longitudinally disposed within the hollow housing 210 in a longitudinal position that is longitudinally coextensive with longitudinal section of the hollow housing 210 that is disposed between the spoon tip 208 and the thinned section 209 of the hollow housing 210. Such a longitudinal position along the hollow housing 210 may provide additional space within the hollow cavity of the hollow housing 210 in order to accommodate the outside dimensions of the electric motor 68. For some embodiments, the electric motor 68 and offset weight 70 may be configured to generate vibration energy at frequencies of about 1 Hz to about 1000 Hz in some cases, about 1 Hz to about 10,000 Hz in some instances. For some embodiments, the electric motor 68 may include a permanent magnet waterproof micromotor having a weight of about 2 grams to about 10 grams, in some cases. Such a motor may have a length of about 20 mm to about 30 mm, a diameter of about 5 mm to about 10 mm, and a rotations per minute (RPM) speed range of up to about 25,000 RPM, more specifically about 10,000 RPM to about 24,000 RPM.

The electric motor 68 of the vibration source 12 may be operatively coupled to the controller 14 by a plurality of conduits which are configured to conduct electrical energy. Such conduits may include an electrical wire harness 212 which is also operatively coupled to a printed circuit board (PCB) 214 of the controller 14. The PCB 214 of the controller 14 is also operatively coupled to the power source 16, which may include a rechargeable battery 216, with a conduit 217 as shown in FIG. 30 and following. The rechargeable battery 216 may be recharged with a recharging cable (not shown) which may be coupled to a recharging port 220 which is disposed on and operatively coupled to the PCB 214 of the controller 14. The recharging port 220 is disposed at a proximal end of the PCB 214 in order to provide convenient access to the recharging port 220 when a removable cap 222 is removed from the proximal end 203 of the stirring wand 202. The removable cap 222 may be threaded to the hollow housing 210 and may include a water proof seal such as an O-ring type seal (not shown) disposed between a proximal portion of the hollow housing 210 and the removable cap 222 to prevent fluids from entering the hollow cavity of the hollow housing 210 during use. The rechargeable battery 216 may also be recharged by any other suitable method such as inductive charging or the like.

The controller 14 may further include a processor 224 operatively coupled to the PCB 214 that may be configured to accept programming instructions, save programmed values and generate control signals to be communicated to the vibration source 12 and components thereof. In some cases, it may be desirable to have certain electronic components of the agitator 200 such as the PCB 214, processor 224 and any other associated components disposed towards the proximal end 203 of the stirring wand 202 in order to avoid high temperatures and liquid exposure associated with the stir section 206 of the stirring wand 202. As such, the PCB 214, battery 216, recharging port 220 and other associated components of the PCB 214 are disposed at a proximal end 203 of the stirring wand 202 within the hollow housing 210 thereof. In some cases, it may also be useful to include electronic components of the PCB 214 such as the processor 224 which are heat tolerant to temperatures up to the temperature of boiling water, that is about 100 degrees Celsius, for at least 5 minutes in some cases. This may be particularly true for any electronic components that may be disposed at or near the stir section 206 which may be continuously submerged in infusion mixtures 26 which are at or near boiling temperatures for extended periods of time. In some cases, such electronic components that include semiconductor components may be made from silicon for use in these embodiments.

For some agitator embodiments 200, the controller 14 or any other suitable portion of the agitator 200 may include a user interface that includes a first switch that may be used to toggle through a plurality of predetermined vibration power levels. For example, in some cases, such a first switch may include a first button 226 that is responsive to finger pressure, may be waterproof and may be depressed in order to toggle between a first power level, a second power level, a third power level, a fourth power level and a fifth power level, with each of these power levels being different from the others.

In some cases, the first power level may represent the lowest power level and the fifth power level represents the highest power level, with the second power level through fourth power levels representing corresponding intermediate power level values. Although some embodiments include the five power levels discussed above, any suitable number of discrete power levels may be used including 6, 7, 8, 9 10 or more power levels which may be selected by a single power level switch or multiple power level switches. It should be noted that varying the vibration energy output by the vibration source 12 at the various power levels may be carried out by configuring the controller 14 to generate varying rotation speed of a motor 68 having an offset weight 70 disposed on the output shaft 72 thereof for such a vibration source embodiment 12.

Regarding the power level set by a user by depressing the first button 226, visual feedback from the agitator to the user may be used to confirm the power level setting selected by the user. For example, a separate indicator light corresponding to each of the five predetermined power levels 1-5 may be emitted from an outside surface of the hollow housing 210 when a corresponding power level is selected. For the agitator embodiment 200 illustrated, a linear array of five indicator lights 227 is disposed adjacent the first button 226. Such an array of indicator lights 227 may be disposed on the PCB 214 and configured to emit light through a waterproof membrane (not shown) of the hollow housing 210 in some cases. The indicator lights 227 may include any suitable type of light source including light emitting diodes (LED) and the like. In some cases, the controller 14 may be configured to illuminate each indicator light 227 of the linear array corresponding a predetermined power level in any fashion that may provide a user friendly interface to indicate the selected power level to a user. For some embodiments, a first indicator light 227 disposed at either end of the linear array may be activated when the first power level is selected. When the second power level is selected, a second indicator light disposed adjacent the first indicator light may then be activated and so on. In some cases, the first indicator light 227 may be deactivated upon activation of the second indicator light 227, or it may also remain on to provide the user with visual “light column” to indicate the power level selected.

For some such agitator embodiments 200, the controller 14 or any other suitable portion of the agitator 200 may include the user interface with a second switch that may be used to toggle through a plurality of predetermined vibration duration periods. For example, in some cases, such a second switch may include a second button 228 that is responsive to finger pressure, may be waterproof, and may be depressed in order to toggle between a first predetermined vibration period, a second predetermined vibration period, a third predetermined vibration period, a fourth predetermined vibration period and a fifth predetermined vibration period, with each of these vibration periods being different from the others.

In some cases, the first vibration period may represent the shortest vibration period and the fifth vibration period may represent the longest vibration period, with the second vibration period through fourth vibration period representing corresponding intermediate vibration period values. Although some embodiments may include the five vibration periods discussed above, any suitable number of discrete vibration periods may be used including 6, 7, 8, 9 10 or more vibration periods which may be selected by a single vibration period switch 106 or multiple vibration period selection switches.

It should be noted that a range of the vibration period durations may be set differently for different processes. For example, for cold brewing, the first vibration period may be set to about 1 hour, the second vibration period about 2 hours, the third vibration period about 4 hours, the fourth vibration period about 9 hours and the fifth vibration period may optionally include a programmable vibration period pattern and/or vibration period that may be controlled remotely such as by a smart phone application or separate remote control device. For some embodiments that are being used for hot brewing, the first vibration period may be set to about 1 minute, the second vibration period about 2 minutes, the third vibration period about 3 minutes, the fourth vibration period about 4 minutes and the fifth vibration period may optionally include a programmable vibration period pattern and/or vibration period that may be controlled remotely such as by a smart phone application or separate remote control device.

Regarding the vibration period set by a user by depressing the second button 228, visual feedback from the agitator to the user may be used to confirm the vibration period setting selected by the user. For example, a separate indicator light corresponding to each of the five predetermined vibration durations 1-5 may be emitted from an outside surface of the hollow housing 210 when a corresponding vibration duration setting is selected. For the agitator embodiment 200 illustrated, a linear array of five indicator lights 229 is disposed adjacent the second button 228. The indicator lights 229 may include any suitable type of light source including light emitting diodes (LED) and the like. Such an array of indicator lights 229 may be disposed on the PCB 214 and configured to emit light through a waterproof membrane (not shown) of the hollow housing 210 in some cases. In some cases, the controller 14 may be configured to illuminate each indicator light 229 of the linear array corresponding a predetermined vibration duration in any fashion that may provide a user friendly interface to indicate the selected vibration duration to a user. For some embodiments, a first indicator light 229 disposed at either end of the linear array corresponding to vibration duration settings may be activated when the first vibration duration is selected. When the second vibration duration is selected, a second indicator light disposed adjacent the first indicator light may then be activated and so on. In some cases, the first indicator light 229 may be deactivated upon activation of the second indicator light 229, or it may also remain on to provide the user with visual “light column” to indicate the vibration duration selected.

In some cases, the controller 14 may also include a speaker 230 which is operatively coupled thereto and which may be disposed on the PCB 214 as shown in FIG. 33. Such a speaker 230 may be disposed at any suitable position on the agitator embodiment 200 and may include a waterproof speaker 230 in some cases. The speaker 230 may also be configured to emit a tone or other audio signal that may alert a user of the agitator 200 to a variety of processes being carried out by the agitator 200. For example, the controller 14 may be configured to emit a tone from the speaker 230 to indicate the passage of time, to indicate completion of a brew cycle including completion of a preselected vibration period, to indicate when vibration energy output has been enabled or disabled and the like. A temperature sensor 232 may also be disposed on the agitator embodiment 200 in any suitable position, such as within the hollow housing 210 at a distal section thereof, and may be operatively coupled to the controller 14, or any suitable component thereof, including the processor 224, in order to provide brew temperature data to the controller 14. In some cases, the temperature sensor 232 may be operatively coupled to the controller 14 by electrical conduits 234.

In use, the agitator 200 may be programmed by a user so as to set a vibration energy power level by sequentially depressing the first button 226 until as desired power level is attained and optionally indicated by the linear array of indicator lights 227. The user may also similarly set the desired vibration duration level by sequentially depressing the second button 228 until a desired vibration duration level is attained and optionally indicated by the linear array of indicator lights 229. The agitator may then be activated to emit vibration energy from an outside surface thereof corresponding to the selected vibration energy power level and vibration energy duration parameters. The stir section 206 and/or any other desired portion of the stirring wand 202 of the agitator 200 may then be put into contact with a desired infusion mixture 26 to achieve a desired effect on an infusion process or extraction process as shown in FIG. 35A. FIG. 35A shows the stir section 206 disposed in contact with the infusion mixture 26 which is disposed within the filter container 30 as an example with an infused liquid 123 being dispensed from the bottom of the filter container 30 and into a cup 301. The stir section 206 may also be disposed within an interior volume of a filter container 78 of a cold brewing system, such as the cold brewing system shown in FIG. 11, and operatively disposed in contact with an infusion mixture 26 disposed within that interior volume. The stir section 206 may also be disposed directly into operative contact with an infusion mixture embodiment 26 which is disposed within an interior volume of the cup 301 which includes a handle configured for grasping by a user for drinking the contents of the cup 301. In some cases, the agitator 200 may be so used to selectively infuse the infusion mixture 26 and end product therefrom with a desired level of dissolved components and undissolved solids to selectively achieve a desired flavor as discussed above with regard to the discussion of the graphical embodiments of FIGS. 16-18. At the end of the vibration duration cycle, an audio signal signifying the end of the process may be emitted from the speaker 230.

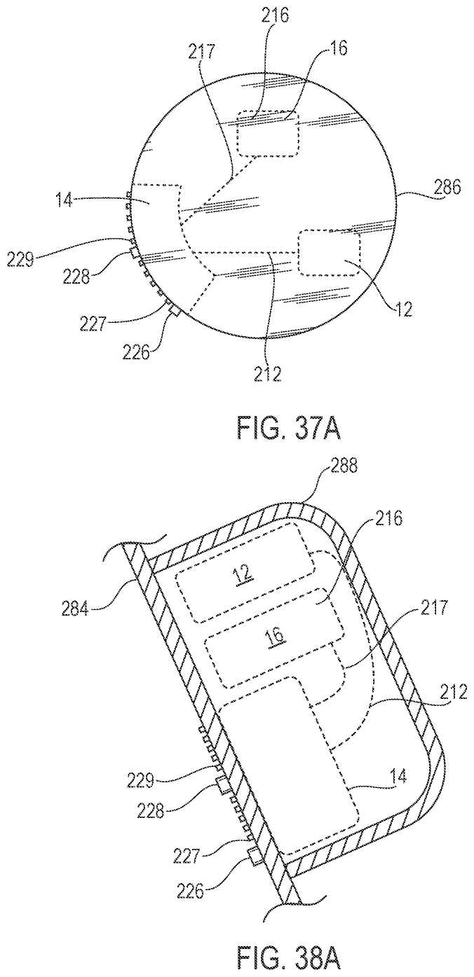

In some cases, it may be useful to enhance the infusion process of a cartridge based brewing system. FIGS. 37-38 show agitator embodiments using a vibration source 12 in refillable/reusable capsules for cartridge based brewing machines such as a Keurig® type brewing machine. In particular, FIG. 37 illustrates an agitator embodiment 280 for enhancing infusion of a liquid that includes a refillable cartridge 282 for cartridge based brewing machines, including a wall 284 disposed about an interior cavity 285 and a filter portion 154 in the wall 284 including a plurality of passages that allow the passage of liquid but prevent the passage of ground material 136. A base 286 may be secured to a bottom of the filter container 282 with the vibration source 12 operatively coupled to the base 286, the power source 16 operatively coupled to the vibration source 12 and the controller 14 in operative communication with the vibration source 12. For some embodiments, the base 286 may include a hollow configuration with a sealed interior volume and the vibration source 12, power source 16 and controller 14 may be disposed within the interior volume of the base 286.

Some embodiments of an agitator 280′ for enhancing infusion of a liquid may include a refillable cartridge 282′ for cartridge based brewing machine which includes the wall 284 disposed about the interior cavity 285 of the refillable cartridge 282′ as shown in FIG. 38. A filter portion 154 may be disposed in the wall 284 and may include a plurality of passages that allow the passage of liquid but prevent the passage of ground material 136. In some cases, the agitator embodiment 280′ may further include a housing 288 with a sealed interior volume wherein the vibration source 12, power source 16 and controller 14 are disposed within the interior volume of the housing 288. Both the agitator embodiment 280 of FIG. 37 and the agitator embodiment 280′ of FIG. 38 may include a removable lid 290 which may have a through hole 291 that passes through the removable lid 290 for the introduction of a desired liquid for an infusion process, such as hot water for coffee brewing etc. The removable lid 290 may be removably secured to the wall 284 of the refillable cartridge embodiments 282, 282′ by any suitable mechanism including threads suitable for a screw on removable lid embodiment 290, mating detents suitable for a snap on removable lid embodiment 290, mating detents and a hinge suitable for a hinged snap on removable lid embodiment 290 or any other suitable configuration. Such a suitable configuration may allow a user to open the removable lid 290 without the use of tools for placement of a desired material for infusion and closing the removable lid 290 to prepare the refillable cartridge 282, 282′ for use in a commercially available machine. Thereafter, the user may easily open the removable lid 290 for cleaning and reuse of the refillable cartridge 282, 282′.

For most refillable cartridge embodiments 282, 282′, filter portion 154, the wall 284, base 286, housing 288, and vibration source 12, controller 14 and power source 16 disposed within either the base 286 or housing 288 should be made from heat tolerant materials or components such as metal or high temperature polymers. For some embodiments, the interior cavity 285 of the refillable cartridge embodiments 282, 282′ may have a volume sufficient to hold at least about 10 grams of dry coffee grounds during an infusion process. In some cases, particularly for cartridge based systems that are configured to brew carafe sized quantities of infused liquids, the interior cavity 285 may have an interior volume sufficient to hold up to about 25 grams or more of dry coffee grounds. In some instances, the interior cavity 285 may include a volume for containment of infusion material of about 20 ml to about 40 ml.

For some agitator embodiments 282, 282′, the vibration source 12, power source 16 and controller 14 may be disposed within the base 286 or housing 288 respectively. For the agitator embodiments 282, 282′, elements such as the vibration source 12, controller 14 and power source 16 may have features, dimensions and materials which are the same as or similar to those of the vibration source 12, controller 14 and power source 16 discussed above.

For example, for convenient control and use, the controller 14 of some agitator embodiments 282, 282′ may be configured to be in wireless communication with a remote controller 108 as shown on the embodiments of FIGS. 6 and 13 discussed above. For example, in some cases, such a remote controller 108 may include a smart phone application that a user may install on their existing equipment if so desired. In other cases, the remote controller 108 may include a separate wireless controller. Such a remote controller 108 may emit a control signal 110 that includes vibration energy emission information to the controller 14, which in some cases may be referred to as the “primary” controller 14. For such embodiments, both the primary controller 14 and remote controller 108 may include a signal emitter, such as an antenna 112, in order to communicate their respective signals to each other.

For some embodiments, in order to provide a desired level of infusion enhancement and control, it may be useful for some vibration source embodiments to emit vibration energy having particular characteristics. For some embodiments, the vibration source 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be configured to produce vibration energy having a vibration acceleration of about 4 m/s2 to about 60 m/s2, a vibration speed of about 7 mm/s to about 55 mm/s, and a vibration displacement of about 0.08 mm to about 0.7 mm. For such embodiments, the controller 14 may be configured to provide a control signal, such as, for example, control signal 110 discussed above, to the vibration source 12 to emit vibration energy having any of these vibration energy parameters. Vibration energy parameters such as these are also shown in the chart of FIG. 19 and controller embodiments 14 may be configured to produce any combination of the vibration energy parameters shown in the chart of FIG. 19 or any other suitable vibration energy parameters.

For the agitator embodiments 282, 282′ shown in FIGS. 37-38, the vibration source may include the electric motor 68 coupled to an offset weight 70 by a shaft 72 as shown in the agitator embodiment of FIG. 8. For the agitator embodiments 282, 282′, the vibration source 12 may be disposed at any suitable location on the wall 284 or base 286 so long as vibration energy emitted from the vibration source 12 is suitably coupled to an infusion material 26 disposed within the cavity 285 of the agitator embodiments 282, 282′. For some embodiments, the electric motor 68 and offset weight 70 may be configured to generate vibration energy at frequencies of about 1 Hz to about 1000 Hz in some cases, about 1 Hz to about 10,000 Hz in some instances.

The electric motor 68 of the vibration source 12 may be operatively coupled to the controller 14 by a plurality of conduits which are configured to conduct electrical energy. Such conduits may include an electrical wire harness 212 which is also operatively coupled to a printed circuit board (PCB) 214 of the controller 14. The PCB 214 is also operatively coupled to the power source 16 which may include a rechargeable battery 216 as shown. The rechargeable battery 216 may be recharged with a recharging cable (not shown) which may be coupled to a recharging port 220 which is disposed on and operatively coupled to the PCB 214 of the controller 14 as shown in the embodiment of FIG. 30 discussed above. The rechargeable battery 216 may also be charged by any other suitable method such as inductive charging or the like.

The controller 14 may further include a processor, such as processor 224 shown in the embodiment of FIG. 30 discussed above, which is operatively coupled to the PCB 214 that may be configured to accept programming instructions, save programmed values and generate control signals to be communicated to the vibration source 12 and components thereof. In some cases, it may also be useful to include electronic components of the PCB 214 such as the processor 224 which are heat tolerant to temperatures up to the temperature of boiling water, that is about 100 degrees Celsius, for at least 5 minutes in some cases. In some cases, such electronic components that include semiconductor components may be made from silicon for use in these embodiments.

For some agitator embodiments 282, 282′, the controller 14 or any other suitable portion of the agitator 282, 282′ may include a user interface that includes a first switch that may be used to toggle through a plurality of predetermined vibration power levels. For example, in some cases, such a first switch may include a first button 226, as shown respectively in FIGS. 37A and 38A, that is responsive to finger pressure, may be waterproof and may be depressed in order to toggle between a first power level, a second power level, a third power level, a fourth power level and a fifth power level, with each of these power levels being different from the others.

In some cases, the first power level may represent the lowest power level and the fifth power level represents the highest power level, with the second power level through fourth power levels representing corresponding intermediate power level values. Although some embodiments include the five power levels discussed above, any suitable number of discrete power levels may be used including 6, 7, 8, 9 10 or more power levels which may be selected by a single power level switch or multiple power level switches. It should be noted that varying the vibration energy output by the vibration source 12 at the various power levels may be carried out by configuring the controller 14 to generate varying rotation speed of a motor 68 having an offset weight 70 disposed on the output shaft 72 thereof for such a vibration source embodiment 12.

Regarding the power level set by a user by depressing the first button 226, visual feedback from the agitator to the user may be used to confirm the power level setting selected by the user. For example, a separate indicator light corresponding to each of the five predetermined power levels 1-5 may be emitted from an outside surface of the base 286 or housing 288 when a corresponding power level is selected. For the agitator embodiments 282, 282′ illustrated, a linear array of five indicator lights 227 is disposed adjacent the first button 226. Such an array of indicator lights 227 may be disposed on the PCB 214 and configured to emit light through a waterproof membrane (not shown) of the base 286 or housing 288 in some cases. In some cases, the controller 14 may be configured to illuminate each indicator light 227 of the linear array corresponding a predetermined power level in any fashion that may provide a user friendly interface to indicate the selected power level to a user. For some embodiments, a first indicator light 227 disposed at either end of the linear array may be activated when the first power level is selected. When the second power level is selected, a second indicator light disposed adjacent the first indicator light may then be activated and so on. In some cases, the first indicator light 227 may be deactivated upon activation of the second indicator light 227, or it may also remain on to provide the user with visual “light column” to indicate the power level selected.

For some such agitator embodiments 282, 282′, the controller 14 or any other suitable portion of the agitator 282, 282′ may include the user interface with a second switch that may be used to toggle through a plurality of predetermined vibration duration periods. For example, in some cases, such a second switch may include a second button 228 that is responsive to finger pressure, may be waterproof, and may be depressed in order to toggle between a first predetermined vibration period, a second predetermined vibration period, a third predetermined vibration period, a fourth predetermined vibration period and a fifth predetermined vibration period, with each of these vibration periods being different from the others.

In some cases, the first vibration period may represent the shortest vibration period and the fifth vibration period may represent the longest vibration period, with the second vibration period through fourth vibration period representing corresponding intermediate vibration period values. Although some embodiments may include the five vibration periods discussed above, any suitable number of discrete vibration periods may be used including 6, 7, 8, 9 10 or more vibration periods which may be selected by a single vibration period switch 106 or multiple vibration period selection switches.

It should be noted that a range of the vibration period durations may be set differently for different processes. For example, for cold brewing, the first vibration period may be set to about 1 hour, the second vibration period about 2 hours, the third vibration period about 4 hours, the fourth vibration period about 9 hours and the fifth vibration period may optionally include a programmable vibration period pattern and/or vibration period that may be controlled remotely such as by a smart phone application or separate remote control device. For some embodiments that are being used for hot brewing, the first vibration period may be set to about 1 minute, the second vibration period about 2 minutes, the third vibration period about 3 minutes, the fourth vibration period about 4 minutes and the fifth vibration period may optionally include a programmable vibration period pattern and/or vibration period that may be controlled remotely such as by a smart phone application or separate remote control device.

Regarding the vibration period set by a user by depressing the second button 228, visual feedback from the agitator to the user may be used to confirm the vibration period setting selected by the user. For example, a separate indicator light corresponding to each of the five predetermined vibration durations 1-5 may be emitted from an outside surface of the base 286 or housing 288 when a corresponding vibration duration setting is selected. For the agitator embodiments 282, 282′ illustrated, a linear array of five indicator lights 229 is disposed adjacent the second button 228. Such an array of indicator lights 229 may be disposed on the PCB 214 and configured to emit light through a waterproof membrane (not shown) of the base 286 or housing 288 in some cases. In some cases, the controller 14 may be configured to illuminate each indicator light 229 of the linear array corresponding a predetermined vibration duration in any fashion that may provide a user friendly interface to indicate the selected vibration duration to a user. For some embodiments, a first indicator light 229 disposed at either end of the linear array corresponding to vibration duration settings may be activated when the first vibration duration is selected. When the second vibration duration is selected, a second indicator light disposed adjacent the first indicator light may then be activated and so on. In some cases, the first indicator light 229 may be deactivated upon activation of the second indicator light 229, or it may also remain on to provide the user with visual “light column” to indicate the vibration duration selected.

In some cases, the controller 14 of agitator embodiments 282, 282′ may also include a speaker 230 which is operatively coupled thereto and which may be disposed on the PCB 214 as shown in the embodiment of FIG. 33 discussed above. Such a speaker 230 may be disposed at any suitable position on the agitator embodiments 282, 282′ and may include a waterproof speaker 230 in some cases. The speaker 230 may also be configured to emit a tone or other audio signal that may alert a user of the agitator 282, 282′ to a variety of processes being carried out by the agitator 282, 282′. For example, the controller 14 may be configured to emit a tone from the speaker 230 to indicate the passage of time, to indicate completion of a brew cycle including completion of a preselected vibration period, to indicate when vibration energy output has been enabled or disabled and the like. A temperature sensor 232 may also be disposed on the agitator embodiments 282, 282′ in any suitable position, such as within the base 286 or housing 288, and may be operatively coupled to the controller 14, or any suitable component thereof, including the processor 224, in order to provide brew temperature data to the controller 14. In some cases, the temperature sensor 232 may be operatively coupled to the controller 14 by electrical conduits 234.

In use, the agitator embodiments 282, 282′ may be programmed by a user so as to set a vibration energy power level by sequentially depressing the first button 226 until as desired power level is attained and optionally indicated by the linear array of indicator lights 227. The user may also similarly set the desired vibration duration level by sequentially depressing the second button 228 until a desired vibration duration level is attained and optionally indicated by the linear array of indicator lights 229. The agitator may then be activated to emit vibration energy from an outside surface thereof corresponding to the selected vibration energy power level and vibration energy duration parameters. The agitator embodiment 282, 282′ may then be positioned within a cartridge based brewing machine and the brewing machine activated to run a brewing cycle. In some cases, the brewing machine itself may be configured to communicate directly with the controller 14 of the agitator embodiments 282, 282′ in order to set the desired vibration energy parameters for the brewing cycle. In some cases, the agitator 282, 282′ may be so used to selectively infuse the infusion mixture 26 and end product therefrom with a desired level of dissolved components and undissolved solids to achieve a desired flavor as discussed above with regard to the discussion of the graphical embodiments of FIGS. 16-18. In some cases, the application of vibration energy to an infusion mixture 26 disposed within a refillable cartridge 282 during a brewing process of a cartridge based brewing machine may be useful to enhance and improve extraction of soluble coffee material from the coffee grounds by evenly and consistently mixing the coffee grounds and water of the infusion mixture 26, for example.

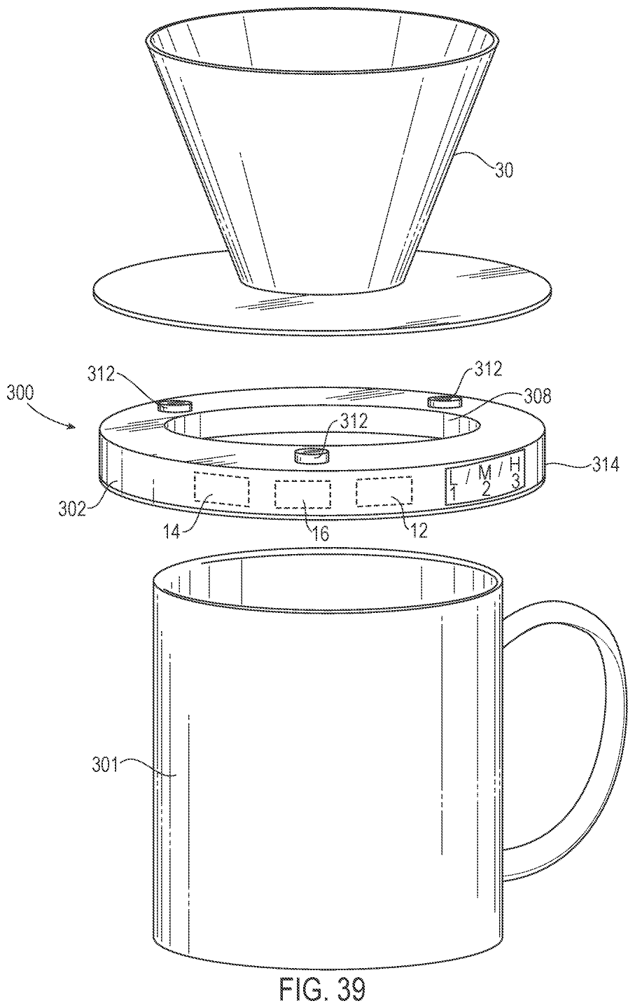

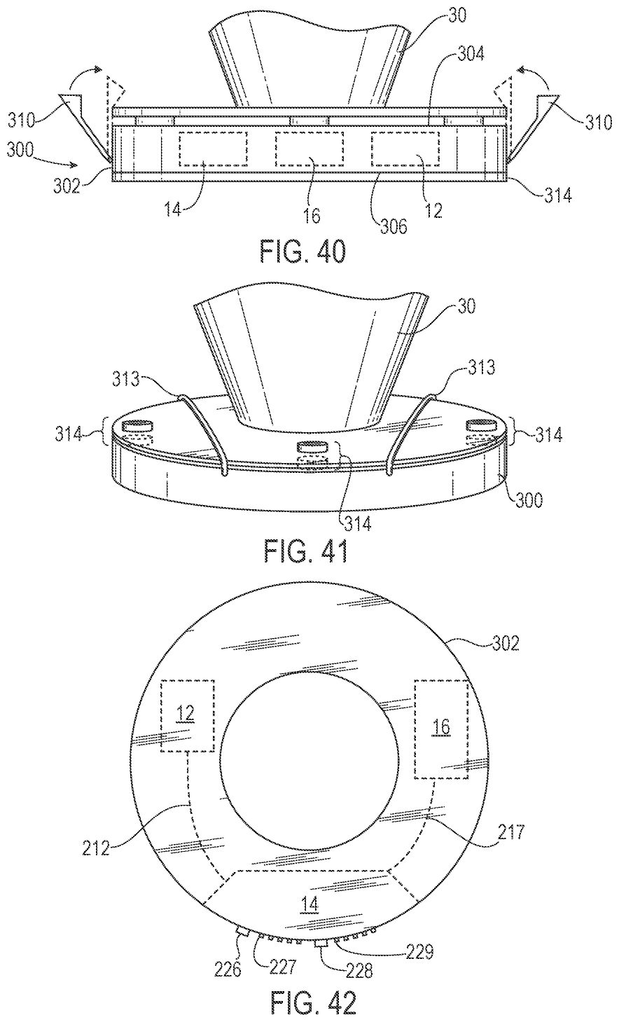

In some cases, it may be desirable to apply vibration energy to an infusion mixture while using a pour over filter container that is disposed directly over a cup or mug. FIGS. 39-42 show an agitator embodiment 300 with the vibration source 12 embodied in a separate attachment that includes an annular donut type shape disposed on a cup 301 beneath a pour over like brewing device. In particular, some embodiments of an agitator 300 for enhancing infusion of a liquid may include a housing 302 including a substantially rigid annular configuration, an upper surface 304, a lower surface 306 which is parallel to the upper surface 304, and a central aperture 308 extending from the upper surface 304 to the lower surface 306. The vibration source 12 may be operatively coupled to the housing, the power source 16 operatively coupled to the vibration source 12 and the controller 14 disposed in operative communication with the vibration source 12. In some instances, the housing 302 has a hollow configuration with a sealed interior volume and the vibration source 12, power source 16 and controller 14 may be disposed within the sealed interior volume of the housing 302.

In addition, in order to releasably secure the housing 302 to a flange of a pour over filter container 30 or the like, the agitator 300 may further include a plurality of filter clips 310 which may be secured to and pivot from the housing 302. The housing 302 may also be releasably secured to the flange of a pour over filter container by use of elastic bands 313 as shown in FIG. 41 or paired magnets 314 also as shown in FIG. 41. For the paired magnet embodiments 314, a first magnet of each pair may be secured to the flange of the pour over filter container 30 and a second magnet of the same magnet pair 314 may be secured to a corresponding position on the housing 302. The agitator 300 may also optionally include one or more vibration contacts 312 which are disposed on the upper surface 304 of the housing 302. In addition, a vibration isolation pad 314 may be disposed on and secured to the lower surface 306 of the housing 302. For the agitator embodiment 300, elements such as the vibration source 12, controller 14 and power source 16 may have features, dimensions and materials which are the same as or similar to those of the vibration source 12, controller 14 and power source 16 discussed above. The same holds true for any other elements of agitator embodiment 300 that have the same reference numbers as those discussed above.

For some agitator embodiments 300, the vibration source 12, power source 16 and controller 14 may be disposed within the housing 302. For the agitator embodiments 300, elements such as the vibration source 12, controller 14 and power source 16 may have features, dimensions and materials which are the same as or similar to those of the vibration source 12, controller 14 and power source 16 discussed above.

For example, for convenient control and use, the controller 14 of some agitator embodiments 300 may be configured to be in wireless communication with a remote controller 108 as shown on the embodiments of FIGS. 6 and 13 discussed above. For example, in some cases, such a remote controller 108 may include a smart phone application that a user may install on their existing equipment if so desired. In other cases, the remote controller 108 may include a separate wireless controller. Such a remote controller 108 may emit a control signal 110 that includes vibration energy emission information to the controller 14, which in some cases may be referred to as the “primary” controller 14. For such embodiments, both the primary controller 14 and remote controller 108 may include a signal emitter, such as an antenna 112, in order to communicate their respective signals to each other.

For some embodiments, in order to provide a desired level of infusion enhancement and control, it may be useful for some vibration source embodiments to emit vibration energy having particular characteristics. For some embodiments, the vibration source 12 may be configured to produce vibration energy having a vibration acceleration of about 0.01 m/s2 to about 200 m/s2, a vibration speed of about 0.01 mm/s to about 200 mm/s, and a vibration displacement of about 0.001 mm to about 2 mm. Furthermore, in some cases, the vibration source 12 may be configured to produce vibration energy having a vibration acceleration of about 4 m/s2 to about 60 m/s2, a vibration speed of about 7 mm/s to about 55 mm/s, and a vibration displacement of about 0.08 mm to about 0.7 mm. For such embodiments, the controller 14 may be configured to provide a control signal, such as, for example, control signal 110 discussed above, to the vibration source 12 to emit vibration energy having any of these vibration energy parameters. Vibration energy parameters such as these are also shown in the chart of FIG. 19 and controller embodiments 14 may be configured to produce any combination of the vibration energy parameters shown in the chart of FIG. 19 or any other suitable vibration energy parameters.

For the agitator embodiments 300 shown in FIGS. 39-42, the vibration source may include the electric motor 68 coupled to an offset weight 70 by a shaft 72 as shown in the agitator embodiment of FIG. 8. For the agitator embodiments 300, the vibration source 12 may be disposed at any suitable location on the housing 302 so long as vibration energy emitted from the vibration source 12 is suitably coupled to an infusion material 26 disposed within the filter container 30 secured thereto. For some embodiments, the electric motor 68 and offset weight 70 may be configured to generate vibration energy at frequencies of about 1 Hz to about 1000 Hz in some cases, about 1 Hz to about 10,000 Hz in some instances.

The electric motor 68 of the vibration source 12 may be operatively coupled to the controller 14 by a plurality of conduits which are configured to conduct electrical energy. Such conduits may include an electrical wire harness 212 which is also operatively coupled to a printed circuit board (PCB) 214 of the controller 14. The PCB 214 is also operatively coupled to the power source 16 which may include a rechargeable battery 216 as shown. The rechargeable battery 216 may be recharged with a recharging cable (not shown) which may be coupled to a recharging port 220 which is disposed on and operatively coupled to the PCB 214 of the controller 14 as shown in the embodiment of FIG. 30 discussed above. The rechargeable battery 216 may also be charged by any other suitable method such as inductive charging or the like.

The controller 14 may further include a processor, such as processor 224 shown in the embodiment of FIG. 30 discussed above, which is operatively coupled to the PCB 214 that may be configured to accept programming instructions, save programmed values and generate control signals to be communicated to the vibration source 12 and components thereof. In some cases, it may also be useful to include electronic components of the PCB 214 such as the processor 224 which are heat tolerant to temperatures up to the temperature of boiling water, that is about 100 degrees Celsius, for at least 5 minutes in some cases. In some cases, such electronic components that include semiconductor components may be made from silicon for use in these embodiments.

For some agitator embodiments 300, the controller 14 or any other suitable portion of the agitator 300 may include a user interface that includes a first switch that may be used to toggle through a plurality of predetermined vibration power levels. For example, in some cases, such a first switch may include a first button 226, as shown in FIG. 42, that is responsive to finger pressure, may be waterproof and may be depressed in order to toggle between a first power level, a second power level, a third power level, a fourth power level and a fifth power level, with each of these power levels being different from the others.

In some cases, the first power level may represent the lowest power level and the fifth power level represents the highest power level, with the second power level through fourth power levels representing corresponding intermediate power level values. Although some embodiments include the five power levels discussed above, any suitable number of discrete power levels may be used including 6, 7, 8, 9 10 or more power levels which may be selected by a single power level switch or multiple power level switches. It should be noted that varying the vibration energy output by the vibration source 12 at the various power levels may be carried out by configuring the controller 14 to generate varying rotation speed of a motor 68 having an offset weight 70 disposed on the output shaft 72 thereof for such a vibration source embodiment 12.

Regarding the power level set by a user by depressing the first button 226, visual feedback from the agitator to the user may be used to confirm the power level setting selected by the user. For example, a separate indicator light corresponding to each of the five predetermined power levels 1-5 may be emitted from an outside surface of the housing 302 when a corresponding power level is selected. For the agitator embodiments 300 illustrated, a linear array of five indicator lights 227 is disposed adjacent the first button 226. Such an array of indicator lights 227 may be disposed on the PCB 214 and configured to emit light through a waterproof membrane (not shown) of the housing 302 in some cases. In some cases, the controller 14 may be configured to illuminate each indicator light 227 of the linear array corresponding a predetermined power level in any fashion that may provide a user friendly interface to indicate the selected power level to a user. For some embodiments, a first indicator light 227 disposed at either end of the linear array may be activated when the first power level is selected. When the second power level is selected, a second indicator light disposed adjacent the first indicator light may then be activated and so on. In some cases, the first indicator light 227 may be deactivated upon activation of the second indicator light 227, or it may also remain on to provide the user with visual “light column” to indicate the power level selected.

For some such agitator embodiments 300, the controller 14 or any other suitable portion of the agitator 300 may include the user interface with a second switch that may be used to toggle through a plurality of predetermined vibration duration periods. For example, in some cases, such a second switch may include a second button 228 that is responsive to finger pressure, may be waterproof, and may be depressed in order to toggle between a first predetermined vibration period, a second predetermined vibration period, a third predetermined vibration period, a fourth predetermined vibration period and a fifth predetermined vibration period, with each of these vibration periods being different from the others.

In some cases, the first vibration period may represent the shortest vibration period and the fifth vibration period may represent the longest vibration period, with the second vibration period through fourth vibration period representing corresponding intermediate vibration period values. Although some embodiments may include the five vibration periods discussed above, any suitable number of discrete vibration periods may be used including 6, 7, 8, 9 10 or more vibration periods which may be selected by a single vibration period switch 106 or multiple vibration period selection switches.

It should be noted that a range of the vibration period durations may be set differently for different processes. For example, for cold brewing, the first vibration period may be set to about 1 hour, the second vibration period about 2 hours, the third vibration period about 4 hours, the fourth vibration period about 9 hours and the fifth vibration period may optionally include a programmable vibration period pattern and/or vibration period that may be controlled remotely such as by a smart phone application or separate remote control device. For some embodiments that are being used for hot brewing, the first vibration period may be set to about 1 minute, the second vibration period about 2 minutes, the third vibration period about 3 minutes, the fourth vibration period about 4 minutes and the fifth vibration period may optionally include a programmable vibration period pattern and/or vibration period that may be controlled remotely such as by a smart phone application or separate remote control device.

Regarding the vibration period set by a user by depressing the second button 228, visual feedback from the agitator to the user may be used to confirm the vibration period setting selected by the user. For example, a separate indicator light corresponding to each of the five predetermined vibration durations 1-5 may be emitted from an outside surface of the housing 302 when a corresponding vibration duration setting is selected. For the agitator embodiments 300 illustrated, a linear array of five indicator lights 229 is disposed adjacent the second button 228. Such an array of indicator lights 229 may be disposed on the PCB 214 and configured to emit light through a waterproof membrane (not shown) of the housing 302 in some cases. In some cases, the controller 14 may be configured to illuminate each indicator light 229 of the linear array corresponding a predetermined vibration duration in any fashion that may provide a user friendly interface to indicate the selected vibration duration to a user. For some embodiments, a first indicator light 229 disposed at either end of the linear array corresponding to vibration duration settings may be activated when the first vibration duration is selected. When the second vibration duration is selected, a second indicator light disposed adjacent the first indicator light may then be activated and so on. In some cases, the first indicator light 229 may be deactivated upon activation of the second indicator light 229, or it may also remain on to provide the user with visual “light column” to indicate the vibration duration selected.

In some cases, the controller 14 of agitator embodiments 300 may also include a speaker 230 which is operatively coupled thereto and which may be disposed on the PCB 214 as shown in the embodiment of FIG. 33 discussed above. Such a speaker 230 may be disposed at any suitable position on the agitator embodiments 300 and may include a waterproof speaker 230 in some cases. The speaker 230 may also be configured to emit a tone or other audio signal that may alert a user of the agitator 300 to a variety of processes being carried out by the agitator 300. For example, the controller 14 may be configured to emit a tone from the speaker 230 to indicate the passage of time, to indicate completion of a brew cycle including completion of a preselected vibration period, to indicate when vibration energy output has been enabled or disabled and the like. A temperature sensor 232 may also be disposed on the agitator embodiments 300 in any suitable position, such as within the housing 302, and may be operatively coupled to the controller 14, or any suitable component thereof, including the processor 224, in order to provide brew temperature data to the controller 14. In some cases, the temperature sensor 232 may be operatively coupled to the controller 14 by electrical conduits 234 as shown in the embodiment of FIG. 30.

In use, the agitator embodiments 300 may be programmed by a user so as to set a vibration energy power level by sequentially depressing the first button 226 until as desired power level is attained and optionally indicated by the linear array of indicator lights 227. The user may also similarly set the desired vibration duration level by sequentially depressing the second button 228 until a desired vibration duration level is attained and optionally indicated by the linear array of indicator lights 229. The agitator may then be activated to emit vibration energy from an outside surface thereof corresponding to the selected vibration energy power level and vibration energy duration parameters. The emitted vibration energy may then be operatively coupled to an infusion mixture disposed within a pour over filter 30 or the like. In some cases, the agitator 300 may be so used to selectively infuse the infusion mixture 26 and end product therefrom with a desired level of dissolved components and undissolved solids to achieve a desired flavor. In some cases, the application of vibration energy to an infusion mixture 26 may be useful to enhance and improve extraction of soluble coffee material from the coffee grounds by evenly and consistently mixing the coffee grounds and water of the infusion mixture 26, for example.

Embodiments illustratively described herein suitably may be practiced in the absence of any element(s) not specifically disclosed herein. Thus, for example, in each instance herein any of the terms “comprising,” “consisting essentially of,” and “consisting of” may be replaced with either of the other two terms. The terms and expressions which have been employed are used as terms of description and not of limitation and use of such terms and expressions do not exclude any equivalents of the features shown and described or portions thereof, and various modifications are possible. The term “a” or “an” can refer to one of or a plurality of the elements it modifies (e.g., “a reagent” can mean one or more reagents) unless it is contextually clear either one of the elements or more than one of the elements is described. Thus, it should be understood that although embodiments have been specifically disclosed by representative embodiments and optional features, modification and variation of the concepts herein disclosed may be resorted to by those skilled in the art, and such modifications and variations are considered within the scope of this disclosure.

With regard to the above detailed description, like reference numerals used therein refer to like elements that may have the same or similar dimensions, materials and configurations. While particular forms of embodiments have been illustrated and described, it will be apparent that various modifications can be made without departing from the spirit and scope of the embodiments of the invention. Accordingly, it is not intended that the invention be limited by the forgoing detailed description.

What is claimed is:

1. An agitator for enhancing infusion of a liquid, comprising:
a filter container, including a wall disposed about an interior cavity, a filter portion in the wall including a plurality of passages that allow the passage of liquid but prevent the passage of ground material;
a base secured to a bottom of the filter container;
a vibration source operatively coupled to the base;
a power source operatively coupled to the vibration source; and
a controller in operative communication with the vibration source.

2. The agitator of claim 1 wherein the base includes a hollow configuration with a sealed interior volume and the vibration source, power source and controller are disposed within the sealed interior volume.

3. The agitator of claim 1 further comprising a radiator secured to and extending upward from the base into the interior cavity, the radiator including a radiator body having an elongate outer contour, a proximal end, a distal end and a longitudinal axis.

4. The agitator of claim 3 wherein the vibration source is disposed on the radiator.

5-6. (canceled)

7. The agitator of claim 3 further comprising an elongate fin secured to and extending radially from the radiator body.

8-10. (canceled)

11. The agitator of claim 1 wherein the power source is in operative communication with the controller.

12. The agitator of claim 1 wherein the controller is configured to control vibration duration, intensity and frequency.

13-14. (canceled)

15. The agitator of claim 1 wherein the controller is further configured to adjust a time schedule of vibration energy delivered from the vibration source based on user input.

16. The agitator of claim 1 wherein the controller further comprises a user interface including a plurality of buttons in order to adjust vibration energy parameters during the brewing process.

17. The agitator of claim 1 wherein the controller is configured to control vibration energy duration, vibration energy displacement, vibration energy frequency, and/or vibration energy emission schedule.

18. (canceled)

19. The agitator of claim 1 wherein the controller is configured for a user to select a vibration energy power level from pre-selected levels of vibration energy power, including low power, medium power and high power.

20-21. (canceled)

22. The agitator of claim 1 wherein the controller is configured to be in wireless communication with a remote controller.

23-26. (canceled)

27. The agitator of claim 1 wherein the vibration source is configured to produce vibration energy having a frequency of about 1 Hz to about 10,000 Hz.

28. An agitator for enhancing infusion of a liquid, comprising:
an elongate stirring wand including a proximal handle section and a stir section that extends distally from the proximal handle section;
a vibration source operatively coupled to the elongate stirring wand;
a power source operatively coupled to the vibration source; and
a controller in operative communication with the vibration source.

29. The agitator of claim 28 wherein the elongate stirring wand includes a hollow housing with a sealed interior volume and the vibration source, power source and controller are disposed within the interior volume.

30. (canceled)

31. The agitator of claim 28 wherein the elongate stirring wand comprises a convex spoon tip secured to a distal end of the stir section.

32. The agitator of claim 28 wherein the vibration source, power source and controller are disposed within proximal handle section.

33. The agitator of claim 28 wherein the vibration source is releasably secured to the proximal handle section.

34. The agitator of claim 28 wherein the vibration source is configured to produce vibration energy having a frequency of about 1 Hz to about 10,000 Hz.

35. An agitator for enhancing infusion of a liquid, comprising:
a refillable cartridge for cartridge based brewing machines, including a wall disposed about an interior cavity, a filter portion in the wall including a plurality of passages that allow the passage of liquid but prevent the passage of ground material;
a base secured to a bottom of the filter container;
a vibration source operatively coupled to the refillable cartridge;
a power source operatively coupled to the vibration source; and
a controller in operative communication with the vibration source.

36. The agitator of claim 35 wherein the base includes a hollow configuration with a sealed interior volume and the vibration source, power source and controller are disposed within the interior volume.

37. The agitator of claim 35 wherein the vibration source is configured to produce vibration energy having a frequency of about 1 Hz to about 10,000 Hz.

38. The agitator of claim 35 wherein
the vibration source is operatively coupled to the wall.

39. The agitator of claim 38 further comprising a housing with a sealed interior volume and wherein the vibration source, power source and controller are disposed within the interior volume.

40. The agitator of claim 38 wherein the vibration source is configured to produce vibration energy having a frequency of about 1 Hz to about 10,000 Hz.

41-46. (canceled)
